(19) United States
(12) Patent Application Publication
(10) Pub. No.: US 2013/0050377 A1
(43) Pub. Date: Feb. 28, 2013

(54) PAPER CONVEYANCE APPARATUS AND INKJET RECORDING APPARATUS

(71) Applicant: Takahiro INOUE, Ashigarakami-gun (JP)

(72) Inventor: Takahiro INOUE, Ashigarakami-gun (JP)

(21) Appl. No.: 13/557,873

(22) Filed: Jul. 25, 2012

(30) Foreign Application Priority Data
Aug. 24, 2011 (JP) 2011-183039

(51) Int. Cl. B41J 2/01; B65H 3/06

(52) U.S. Cl. 347/104; 271/109

(57) ABSTRACT

An aspect of the present invention provides a paper conveyance apparatus which conveys cut sheet paper, including: a drum which conveys the paper by wrapping the paper around an outer circumferential surface of the drum and rotating; a pressing roller which presses a front surface of the paper at a prescribed position on the outer circumferential surface of the drum to cause a rear surface of the paper to make tight contact with the outer circumferential surface of the drum; and a back tension application device which applies a back tension to the paper which is introduced between the drum and the pressing roller. In the pressing roller, an outer diameter may be formed so as to become smaller from a center towards respective ends, or spiral-shaped grooves may be formed from a center towards respective ends in a circumferential surface of the pressing roller.

### BACKGROUND OF THE INVENTION

1. Field of the Invention

The present invention relates to a paper conveyance apparatus and an inkjet recording apparatus, and more particularly to technology for conveying paper on drums.

2. Description of the Related Art

A drum conveyance method is known as a paper conveyance method in an inkjet recording apparatus. In a drum conveyance method, paper is conveyed by the paper being wrapped about an outer circumferential surface of a drum and the drum being rotated.

Japanese Patent Application Publication No. 2009-220954 discloses an inkjet recording apparatus which employs a drum conveyance method. This inkjet recording apparatus adopts a composition in which, in order to prevent the occurrence of floating and creasing in the paper wrapped about the drum, a back tension is applied to the paper while the paper is transferred from one drum to another drum. More specifically, a back tension is applied to the paper by providing a guide plate along the paper conveyance path of the paper on the preceding drum and suctioning the rear surface of the paper by this guide plate.

### SUMMARY OF THE INVENTION

In a location where the paper is required to be flat, such as in a printing unit, a pressing roller is provided at an outer circumferential surface of the drum in order to cause the paper to make tight contact with the drum. The pressing roller presses the front surface of the paper which is wrapped about the outer circumferential surface of the drum and causes the paper to make tight contact with the drum. When a pressing roller of this kind is provided, then the paper is progressively caused to make tight contact with the drum, successively from the leading end side of the paper. In this case, if the paper is not supported, then the paper becomes slack and creases occur when the paper is pressed.

In the case of Japanese Patent Application Publication No. 2009-220954, it is possible to guide the paper between the drum and the pressing roller without bending, due to the effects of the back tension, while the paper is guided by the guide plate. However, when the paper has passed the conveyance guide, back tension ceases to be applied to the paper, the paper becomes slack in the trailing end portion thereof, and a problem arises in that creasing occurs when the paper is pressed.

Furthermore, since Japanese Patent Application Publication No. 2009-220954 adopts a composition in which a rear surface of the paper is caused to make tight contact with a guide plate by suctioning, thereby applying a back tension to the paper, then if an image has already been recorded on the rear surface side (for example, in the case of double-side printing), there is a drawback in that this image becomes damaged.

The present invention was devised in view of these circumstances, an object thereof being to provide a paper conveyance apparatus and an inkjet recording apparatus whereby paper can be conveyed without giving rise to creasing or floating.

The means for solving the problems are described below.
[1] A first mode of the present invention provides a paper conveyance apparatus which conveys cut sheet paper; comprising: a drum which conveys the paper by wrapping the paper around an outer circumferential surface of the drum and rotating; a pressing roller, at least an outer peripheral portion of which is formed by an elastic body, the pressing roller pressing a front surface of the paper at a prescribed position on the outer circumferential surface of the drum to cause a rear surface of the paper to make tight contact with the outer circumferential surface of the drum; and a back tension application device which applies a back tension to the paper which is introduced between the drum and the pressing roller.

According to the first mode, the paper is pressed by the pressing roller while a back tension is applied to the paper. By applying a back tension, it is possible to stretch deformation (distortion) which has occurred in the paper, and by pressing the paper with the pressing roller in this state, it is possible effectively to suppress the occurrence of creases or floating. Furthermore, the paper is pressed by a pressing roller so as to stretch the paper. Consequently, it is possible to cause the paper to make tight contact with the circumferential surface of the drum, without giving rise to creases or floating. If the paper is pressed without applying a back tension, then the paper is simply squashed by the pressing roller, and therefore the distortion of the paper collects in the trailing end and creases arise in the trailing end of the paper. By applying a back tension, it is possible to stretch and eliminate this distortion.
[2] A second mode of the present invention provides the paper conveyance apparatus as defined in the first mode, wherein an outer diameter of the pressing roller is formed so as to become smaller from a center towards respective ends.

According to the second mode, the paper is pressed by the pressing roller which is formed in such a manner that the outer diameter of the roller becomes smaller from the center towards either end thereof. The pressing roller formed in this way presses the paper so as to stretch the paper from the center towards the outer sides. By pressing the paper with the pressing roller in this way, while applying a back tension, it is possible to apply tension to the paper in the width direction also. Consequently, it is possible to cause the paper to make tight contact with the circumferential surface of the drum, without giving rise to creases or floating, even in the corners.
[3] A third aspect of the present invention provides the paper conveyance apparatus as defined in the first or the second mode, wherein an outer diameter differential and a pressing force of the pressing roller are set so as to make tight contact with a whole region of the paper in a width direction thereof.

According to the third mode, the outer diameter differential and the pressing force of the pressing roller are set in such a manner that the pressing roller makes tight contact with the whole region of the paper in the width direction. By making the circumferential surface of the pressing roller contact the whole region of the paper in the width direction, it is possible to press the paper up to the end portions in the width direction. Consequently, the occurrence of creases and floating can be prevented reliably, even in the ends of the paper in the width direction.
[4] A fourth aspect of the present invention provides the paper conveyance apparatus as defined in any one of the first to the third mode, wherein a plurality of the pressing rollers having mutually different outer diameter differentials are prepared, and the plurality of the pressing rollers are exchangeable.

According to the fourth mode, a plurality of pressing rollers having mutually different outer diameter differentials are prepared, and the plurality of the pressing rollers are exchangeable. The force acting in the width direction of the paper (the force stretching the paper in the width direction) varies depending on the shape of the pressing roller. By changing the pressing rollers in accordance with the type of paper and the extent of the deformation occurring in the paper, and the like, it is possible to cause the paper to make tight contact with the drum by pressing the paper appropriately.
[5] A fifth mode of the present invention provides the paper conveyance apparatus as defined in the first mode, wherein spiral-shaped grooves are formed from a center towards respective ends in a circumferential surface of the pressing roller.

According to the fifth mode, the paper is pressed by the pressing roller while a back tension is applied to the paper. By applying a back tension, it is possible to stretch deformation (distortion) which has occurred in the paper, and by pressing the paper with the pressing roller in this state, it is possible effectively to suppress the occurrence of creases or floating. Furthermore, the paper is pressed by using a pressing roller which is formed in such a manner that spiral grooves are formed therein from the center towards either end thereof. The pressing roller formed in this way presses the paper so as to stretch the paper from the center towards the outer sides. By pressing the paper with the pressing roller in this way, while applying a back tension, it is possible to apply tension to the paper in the width direction also. Consequently, it is possible to cause the paper to make tight contact with the circumferential surface of the drum, without giving rise to creases or floating, even in the corners. If the paper is pressed without applying a back tension, then the paper is simply squashed by the pressing roller, and therefore the distortion of the paper collects in the trailing end and creases arise in the trailing end of the paper. By applying a back tension, it is possible to stretch and eliminate this distortion.
[6] A sixth mode of the present invention provides the paper conveyance apparatus as defined in the fifth mode, wherein a groove depth and a pressing force of the pressing roller are set so as to make tight contact with a whole region of the paper in a width direction thereof.

According to the sixth mode, a groove depth and a pressing force of the pressing roller are set so as to make tight contact with a whole region of the paper in a width direction thereof. Consequently, the occurrence of creases and floating can be prevented reliably, even in the ends of the paper in the width direction.
[7] A seventh mode of the present invention provides the paper conveyance apparatus as defined in the fifth or the sixth mode, wherein a plurality of the pressing rollers having mutually different groove inclination angles are prepared, and the plurality of the pressing rollers are exchangeable.

According to the seventh mode, a plurality of pressing rollers having mutually different groove inclination angles are prepared, and the plurality of the pressing rollers are exchangeable. The force acting in the width direction of the paper (the force stretching the paper in the width direction) varies depending on the inclination angle of the spiral-shaped grooves formed in the pressing roller. By changing the pressing rollers in accordance with the type of paper and the extent of the deformation occurring in the paper, and the like, it is possible to cause the paper to make tight contact with the drum by pressing the paper appropriately.
[8] An eighth mode of the present invention provides the paper conveyance apparatus as defined in any one of the first to the seventh mode, wherein the back tension application device applies a back tension to the paper by suctioning the front surface of the paper at a position immediately before the paper is introduced between the drum and the pressing roller.

According to the eighth mode, the surface of the paper is suctioned at a position immediately before being introduced between the drum and the pressing roller, thereby applying a back tension to the paper. Consequently, it is possible to introduce the paper in between the drum and the pressing roller without the occurrence of slackness, right up to the very end of the paper. By applying a back tension through suctioning the front surface of the paper, then even if an image has been recorded on the rear surface (for example, during rear surface printing), it is possible to apply a back tension without damaging the image.
[9] A ninth mode of the present invention provides the paper conveyance apparatus as defined in the eighth mode, wherein the back tension application device comprises: a paper guide which has a guide surface on which the front surface of the paper slides, with a suction hole being formed in this guide surface; and a suctioning device which causes the front surface of the paper to make tight contact with the guide surface by suctioning from the suction hole.

According to the ninth mode, by suctioning the front surface of the paper, a back tension is applied as the paper is conveyed while making tight contact with the guide surface. Consequently, it is possible to stabilize the travel of the paper, as well as applying a back tension in a reliable fashion.
[10] A tenth mode of the present invention provides the paper conveyance apparatus as defined in any one of the first to the ninth mode, wherein the drum has a suction holding device which suctions and holds a rear surface of the paper wrapped around the outer circumferential surface of the drum.

According to the tenth mode, the paper is conveyed on a drum while the rear surface thereof is suctioned to the outer circumferential surface of the drum. Therefore, it is possible to cause the paper to make tight contact with the outer circumferential surface of the drum, more reliably.
[11] An eleventh mode of the present invention provides the paper conveyance apparatus as defined in any one of the first to the tenth mode, wherein the drum has a leading end gripping device which grips a leading end of the paper.

According to the eleventh mode, the leading end of the paper is gripped and conveyed on a drum. By this means, it is possible to convey the paper without slipping.
[12] A twelfth mode of the present invention provides an inkjet recording apparatus, comprising: the paper conveyance apparatus as defined in any one of the first to the eleventh mode; and an inkjet head which ejects an ink droplet onto the front surface of the paper conveyed by the drum.

According to the twelfth mode, the paper can be conveyed without giving rise to floating or creases, and therefore the an image of high quality can be recorded. Furthermore, the paper can be prevented from contacting the inkjet head, then stable operation can be achieved. Moreover, in the case of double-side printing also, it is possible to print an image without damaging an image that has already been printed on the paper.

According to the above modes of the present invention, it is possible to convey paper without giving rise to creasing or floating. Consequently, an image of high quality can be recorded.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing showing one embodiment of an inkjet recording apparatus according to the present invention;

FIG. 2 is a block diagram showing the general composition of a control system of an inkjet recording apparatus;

FIG. 3 is a side view diagram showing the general composition of a paper conveyance mechanism in an image reading unit;

FIG. 4 is a perspective diagram showing the general composition of a paper conveyance mechanism in an image reading unit;

FIG. 5 is a plan diagram showing a composition of a pressing roller;

FIG. 6 is a lower surface diagram of the paper guide (a plan diagram of the guide surface);

FIGS. 7A and 7B are illustrative diagrams of the action of a pressing roller and a back tension application apparatus;

FIGS. 8A and 8B are illustrative diagrams of the action of a pressing roller;

FIG. 9 is a plan diagram showing a further mode of a pressing roller;

FIG. 10 is a diagram showing a relative path of movement of grooves with respect to paper;

FIGS. 11A and 11B are diagrams showing further modes of the guide surface of the paper guide;

FIG. 12 is a diagram showing yet a further mode of the guide surface of the paper guide;

FIGS. 13A and 13B are diagrams showing yet further modes of the guide surface of the paper guide;

FIGS. 14A to 14G are diagrams showing further modes of the suction holes formed in the guide surface;

FIGS. 15A to 15C are diagrams showing yet further modes of the suction holes formed in the guide surface;

FIG. 16 is a diagram showing a further mode of the suction holes;

FIGS. 17A to 17C are diagrams showing further modes of a paper guide installation method;

FIGS. 18A to 18C are diagrams showing further modes of a paper guide; and

FIG. 19 is a diagram showing a further mode of a paper guide.

### DETAILED DESCRIPTION OF THE PREFERRED EMBODIMENTS

### ((General Composition of Inkjet Recording Apparatus))

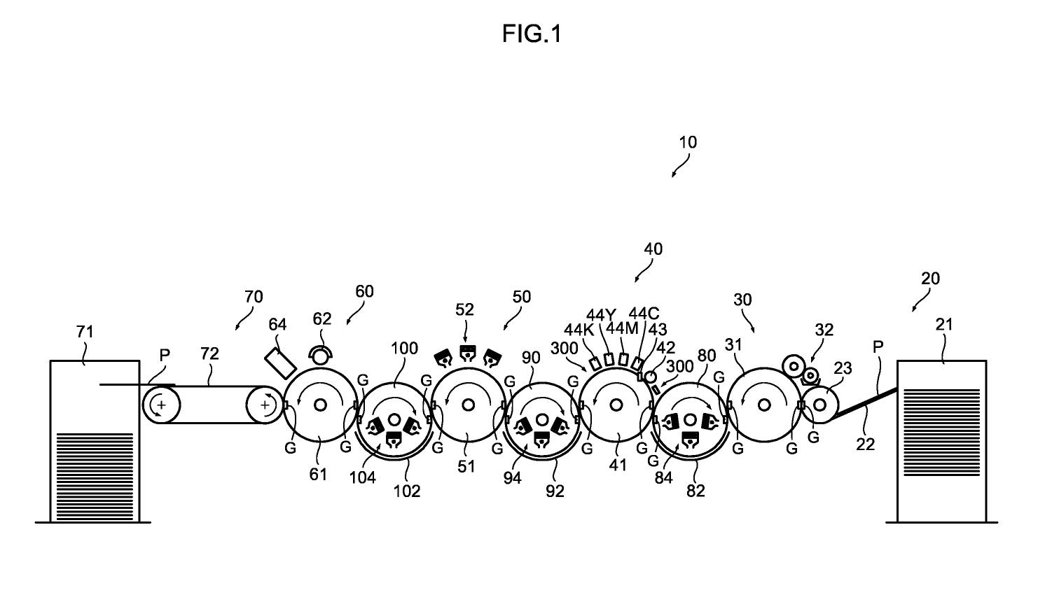

FIG. 1 is a general schematic drawing showing one embodiment of an inkjet recording apparatus relating to the present invention.

The inkjet recording apparatus 10 shown in FIG. 1 is an apparatus which prints by an inkjet method onto cut sheet paper P, using an aqueous ink (an ink in which a coloring material such as dye or pigment is dissolved or dispersed in water or a solvent that is soluble in water), and includes a paper supply unit 20 which supplies paper P, a treatment liquid application unit 30 which applies a prescribed treatment liquid to a printing surface of the paper P, an image recording unit 40 which forms a color image by ejecting droplets of ink of the respective colors of C (cyan), M (magenta), Y (yellow) and K (black) onto a printing surface of the paper P, from an inkjet head, an ink drying unit 50 which dries the ink droplets that have been ejected onto the paper P, a fixing unit 60 which fixes the image recorded on the paper P, and a recovery unit 70 which recovers paper P after printing.

Conveyance drums 31, 41, 51, 61 are provided respectively as conveyance devices for the paper P, in the treatment liquid application unit 30, the image recording unit 40, the ink drying unit 50 and the fixing unit 60. The paper P is conveyed through the treatment liquid application unit 30, the image recording unit 40, the ink drying unit 50 and the fixing unit 60, by means of these conveyance drums 31, 41, 51, 61.

The conveyance drums 31, 41, 51, 61 are formed in a round cylindrical shape, so as to correspond to the paper width. The conveyance drums 31, 41, 51, 61 rotate by being driven by motors (not illustrated) (in FIG. 1, the drums rotate in the counter-clockwise direction). The paper P is conveyed by being wrapped about the outer circumferential surface of the conveyance drums 31, 41, 51, 61.

Grippers are provided on the circumferential surface of each of the conveyance drums 31, 41, 51, 61. The paper P is conveyed with the leading end portion thereof being gripped by a gripper. In the present embodiment, grippers G are provided in two positions on the circumferential surface of the conveyance drums 31, 41, 51, 61. The grippers G are arranged at a spacing of 180° apart. By this means, it is possible to convey two sheets of paper in one revolution.

Furthermore, a suction holding mechanism which suctions and holds paper P which has been wrapped about the outer circumferential surface is provided in each of the conveyance drums 31, 41, 51, 61. In the present embodiment, the paper P is suctioned and held on the outer circumferential surface by using air pressure (negative pressure). Therefore, a plurality of suction holes are formed in the outer circumferential surfaces of the conveyance drums 31, 41, 51, 61. The paper P is suctioned and held on the outer circumferential surfaces of the respective conveyance drums 31, 41, 51, 61, due to the rear surface of the paper P being suctioned from the suction holes. The suction holding mechanism can employ a method which use suction motor and/or suction pump connected to the respective conveyance drums 31, 41, 51, 61 and/or a method which uses static electricity (a so-called electrostatic suction method).

Transfer drums 80, 90, 100 (rotating conveyance devices) are arranged respectively between the treatment liquid application unit 30 and the image recording unit 40, between the image recording unit 40 and the ink drying unit 50, and between the ink drying unit 50 and the fixing unit 60, The paper P is conveyed between the respective units by means of these transfer drums 80, 90, 100.

The transfer drums 80, 90, 100 are composed as round cylindrical frames, which correspond to the paper width. The transfer drums 80, 90, 100 rotate by being driven by motors (not illustrated) (in FIG. 1, the drums rotate in the clockwise direction).

Grippers G are provided on the circumferential surface of each transfer drum 80, 90, 100. The paper P is conveyed with the leading end portion thereof being gripped by a gripper G. In the present embodiment, grippers G are provided at two locations on the outer circumferential portion of each transfer drum 80, 90, 100. The grippers G are arranged at a spacing of 180° apart. By this means, it is possible to convey two sheets of paper in one revolution.

Circular arc-shaped guide plates 82, 92, 102 are arranged along the conveyance path of the paper P, below each of the transfer drums 80, 90, 100. The paper P which is conveyed by the transfer drums 80, 90, 100 is conveyed while the rear surface of the paper P (the surface on the opposite side to the printing surface) is guided by the guide plates 82, 92, 102.

Furthermore, driers 84, 94, 104 which blow a warm air flow towards the paper P conveyed by the transfer drum 80 are provided inside each of the transfer drums 80, 90, 100 (in the present embodiment, three driers are provided along the conveyance path of the paper P). The warm air flows blown out from the driers 84, 94, 104 during this conveyance process strike a printing surface of the paper P conveyed by the transfer drums 80, 90, 100. Consequently, the paper P can undergo a drying process during its conveyance by the transfer drums 80, 90, 100.

The driers 84, 94, 104 may be composed so as to heat the paper P by radiating heat from infrared heaters, or the like, (so-called heating by radiation), rather than a composition where the paper P is heated by blowing a warm air flow.

The paper P supplied from the paper supply unit 20 is conveyed successively from the conveyance drum 31, to the transfer drum 80, to the conveyance drum 41, to the transfer drum 90, to the conveyance drum 51, to the transfer drum 100, to the conveyance drum 61, and is finally recovered by the recovery unit 70. From the paper supply unit 20 and until the recovery of the paper P in the recovery unit 70, the paper P is subjected to prescribed processing and an image is recorded on the printing surface.

The composition of the respective units of the inkjet recording apparatus 10 according to the present embodiment is described in detail below.

### (Paper Supply Unit)

The paper supply unit 20 supplies cut sheet paper P, cyclically, one sheet at a time. The paper supply unit 20 is principally constituted by a paper supply apparatus 21, a paper supply tray 22 and a transfer drum 23.

The paper supply apparatus 21 supplies paper P stacked in a magazine (not illustrated), successively, one sheet at a time from the upper side, to the paper supply tray 22.

The paper supply tray 22 outputs the paper P supplied from the paper supply apparatus 21, to the transfer drum 23.

The transfer drum 23 receives the paper P output from the paper supply tray 22, and rotates so as to transfer the paper P to the conveyance drum 31 of the treatment liquid application unit 30.

The paper P is not limited in particular, but it is possible to use generic printing paper which is used in general offset printing, or the like, (paper which is principally made of cellulose, such as so-called top-grade paper, coated paper, art paper, and the like). In the present embodiment, coated paper is used. Coated paper is high-grade or medium-grade paper which does not generally have a surface treatment and which has a coating layer provided on the surface thereof by applying a coating material. More specifically, art paper, coated paper, lightweight coated paper or fine coated paper are desirable papers to use.

If printing is carried out on a generic printing paper by an inkjet method, then bleeding, and the like, occurs and image quality is impaired. Therefore, in order to prevent problems of this kind, in the inkjet recording apparatus 10 according to the present embodiment, a prescribed treatment liquid is applied to the printing surface of the paper P in the subsequent treatment liquid application unit 30.

### (Treatment Liquid Application Unit)

The treatment liquid application unit 30 applies a prescribed treatment liquid to the printing surface of the paper P. The treatment liquid application unit 30 principally includes a conveyance drum which conveys the paper P (called “treatment liquid application drum” below) 31, and an application apparatus 32 which applies a prescribed treatment liquid to the printing surface of the paper P conveyed by the treatment liquid application drum 31.

The treatment liquid application drum 31 receives paper P from the transfer drum 23 of the paper supply unit 20 (by gripping the leading end of the paper P with a gripper G), and conveys the paper P along a prescribed conveyance path by rotating.

The application apparatus 32 applies a prescribed treatment liquid by a roller to the printing surface of the paper P which is conveyed by the treatment liquid application drum 31. More specifically, an application roller on the circumferential surface of which treatment liquid has been deposited is pressed and abutted against the printing surface of the paper P which is conveyed by the treatment liquid application drum 31, thereby applying treatment liquid onto the printing surface of the paper P. The treatment liquid is applied to a uniform thickness.

The treatment liquid applied by the application apparatus 32 is constituted by a liquid which includes an aggregating agent that aggregates components in the ink composition.

The aggregating agent used may be a compound capable of changing the pH of the ink composition, or a multivalent metal salt, or a polyallylamine.

Desirable examples of a compound capable of lowering the pH are acidic materials having high water solubility (such as phosphoric acid, nitric acid, malonic acid, citric acid, or derivatives or salts of these compounds, or the like). It is possible to use either one type only, or a combination of two or more types, of acid material. By this means, the aggregating properties are raised and the whole of the ink can be solidified.

Furthermore, desirably, the pH (25° C.) of the ink composition is no less than 8.0, and the pH (25° C.) of the treatment liquid is in the range of 0.5 to 4. Consequently, it is possible to achieve good image density and resolution and high speed inkjet recording.

Furthermore, it is possible to include additives in the treatment liquid. For example, it is possible to include commonly known additives, for example, an anti-drying agent (humidifying agent), an anti-fading agent, an emulsion stabilizer, a permeation promoter, an ultraviolet light absorber, an antibacterial agent, an antiseptic agent, a pH adjuster, a surface tension adjuster, an antifoaming agent, a viscosity adjuster, a dispersant, a dispersion stabilizer, an anti-rusting agent, a chelating agent, or the like.

By applying a treatment liquid of this kind to the printing surface of the paper P in advance of printing, the occurrence of feathering and bleeding, or the like, can be prevented, and printing of high quality can be performed, even if using general printing paper.

In the treatment liquid application unit 30 having the composition described above, the paper P is held on a treatment liquid application drum 31 and is conveyed along a prescribed conveyance path. During this conveyance process, treatment liquid is applied to the printing surface from an application apparatus 32.

The paper P having treatment liquid applied to the printing surface thereof is then transferred from the treatment liquid application drum 31 to the transfer drum 80 at a prescribed position. Thereupon, the paper P is conveyed along the prescribed conveyance path by the transfer drum 80 and is transferred onto the conveyance drum 41 of the image recording unit 40.

Here, as described above, a drier 84 is arranged inside the transfer drum 80, and a warm air flow is blown towards the guide plate 82. A warm air flow is blown onto the printing surface of the paper P during the course of the conveyance of the paper P from the treatment liquid deposition unit 30 to the image recording unit 40 by the transfer drum 80, thereby drying the treatment liquid which has been applied to the printing surface (namely, evaporating off the solvent component in the treatment liquid).

### (Image Recording Unit)

The image recording unit 40 forms a color image on the printing surface of the paper P by ejecting ink droplets of the respective colors of C, M, Y, K onto the printing surface of the paper P. This image recording unit 40 principally includes: a conveyance drum (hereinafter, called “image recording drum”) 41 which conveys the paper P; a pressing roller 42 which presses the printing surface of the paper P and causes the rear surface of the paper P to make tight contact with a circumferential surface of the image recording drum 41; a paper floating detection sensor 43 which detects floating of the paper P; inkjet heads 44C, 44M, 44Y, 44K which form an image by ejecting ink droplets of the respective colors of C, M, Y, K onto the paper P; and a back tension application apparatus 300 which applies a back tension to the paper P by suctioning the front surface (printing surface) of the paper P immediately before the pressing roller 42.

The image recording drum 41 receives paper P from the transfer drum 80 (by gripping the leading end of the paper P with a gripper G), and conveys the paper P along a prescribed conveyance path by rotating.

The pressing roller 42 is constituted by a rubber roller having substantially the same width as the image recording drum 41 (a roller of which at least the outer circumferential portion is made of rubber (an elastic body)), and is arranged in the vicinity of the paper receiving position of the image recording drum 41 (the position where paper P is received from the transfer drum 80). The front surface of the paper P transferred from the transfer drum 80 to the image recording drum 41 is pressed by the paper pressing roller 42 and the rear surface of the paper P is thereby caused to make tight contact with the outer circumferential surface of the image recording drum 41.

Here, the outer shape of the pressing roller 42 is formed in a so-called crown shape. In other words, the outer circumference of the pressing roller 42 is formed so as to become smaller from the center towards either end. By pressing the front surface of the paper P with a pressing roller 42 having a shape of this kind, it is possible to press the paper P while stretching the paper P in the width direction. By pressing the paper P with the pressing roller 42 while applying a back tension to the paper P by the back tension application apparatus 300, it is possible to wrap the paper P about the circumferential surface of the image recording drum 41 without giving rise to creasing or floating of the paper P, even in the corners of the paper P. This point is described in detail below.

The paper floating detection sensor 43 detects floating of the paper P passing the pressing roller 42 (a prescribed amount of floating or more from the outer circumferential surface of the image recording drum 41). The paper floating detection sensor 43 is constituted by a laser emitter 43A which emits laser light and a laser receiver 43B which receives the laser light.

The laser emitter 43A emits laser light parallel to the axis of the image recording drum 41, from one end of the image recording drum 41 toward the other end thereof, at a position a prescribed height above the outer circumferential surface of the image recording drum 41 (namely, a position at the height of the upper limit of the permissible range of floating).

The laser receiver 43B is arranged so as to oppose the laser emitter 43A on the other side of the path of travel of the paper P by the image recording drum 41, and receives laser light emitted by the laser emitter 43A.

When floating equal to or greater than the permissible value occurs in the paper P which is conveyed by the image recording drum 41, then the laser light emitted from the laser emitter 43A is blocked by the paper P. As a result of this, the amount of laser light received by the laser receiver 43B declines. The paper floating detection sensor 43 detects floating of the paper P by detecting the amount of laser light received by the laser receiver 43B. More specifically, the amount of laser light received by the laser receiver 43B is compared with a threshold value, and it is judged that floating (floating equal to or exceeding a permissible value) has occurred if the amount of laser light received is equal to or less than the threshold value.

If floating equal to the permissible value or greater is detected, then rotation of the image recording drum 41 is halted and the conveyance of the paper P is halted.

The paper floating detection sensor 43 is composed in such a manner that the height of the laser light emitted from the laser emitter 43A (the height of the laser light from the outer circumferential surface of the image recording drum 41) can be adjusted. Consequently, it is possible to set the permissible range of floating to any desired range.

The four inkjet heads 44C, 44M, 44Y, 44K are disposed after the paper floating detection sensor 43 and are arranged at uniform intervals along the conveyance direction of the paper P. The inkjet heads 44C, 44M, 44Y, 44K are constituted by line heads which correspond to the paper width, and nozzle surfaces are formed on the lower surfaces thereof (the surfaces which oppose the outer circumferential surface of the image recording drum 41). On the nozzle surface, nozzles are arranged at uniform pitch in a direction that is perpendicular to the conveyance direction of the paper P (to form a nozzle row). The inkjet heads 44C, 44M, 44Y, 44K each eject ink droplets towards the image recording drum 41 from the nozzles.

The ink used in the inkjet recording apparatus 10 according to the present embodiment is an aqueous ultraviolet-curable ink, which contains a pigment, polymer particles and a water-soluble polymerizable compound that is polymerized by an active energy beam. Aqueous ultraviolet-curable ink can be cured by irradiating ultraviolet light, and has properties such as excellent weatherproofing and high film strength.

The pigment used is a water-dispersible pigment in which at least a portion of the surface of the pigment is coated with a polymer dispersant.

The polymer dispersant employs a polymer dispersant having an acid value of 25 to 1000 (KOHmg/g). In this case, self-dispersion stability is good and aggregating properties upon contact with the treatment liquid are good.

The polymer particles use self-dispersing polymer particles having an acid value of 20 to 50 (KOHmg/g). In this case, self-dispersion stability is good and aggregating properties upon contact with the treatment liquid are good.

From the viewpoint of impeding reaction between the aggregating agent, the pigment and the polymer particles, the polymerizable compound is desirably an anionic or cationic polymerizable compound and preferably is a polymerizable compound having a solubility of no less than 10 wt % (and more desirably, no less than 15 wt %) with respect to water.

Furthermore, the ink includes an initiator which starts polymerization of the polymerizable compound by an active energy beam. The initiator may include a suitably selected compound which is capable of starting a polymerization reaction by application of an active energy beam; for example, it is possible to use an initiator (for example, a photopolymerization initiator) which creates an active species (radical, acid, base, or the like) upon application of a beam of radiation, light or an electron beam. An initiator may also be included in treatment liquid, and should be included in at least one of the ink and the treatment liquid.

Furthermore, the ink contains 50 to 70 wt % of water. Moreover, it is possible to include additives in the ink. For example, it is possible to include commonly known additives, such as a water-soluble organic solvent or an anti-drying agent (humidifying agent), an anti-fading agent, an emulsion stabilizer, a permeation promoter, an ultraviolet light absorber, an antibacterial agent, an antiseptic agent, a pH adjuster, a surface tension adjuster, an antifoaming agent, a viscosity adjuster, a dispersant, a dispersion stabilizer, an anti-rusting agent, a chelating agent, or the like.

The back tension application apparatus 300 suctions the upper surface of the paper P conveyed by the image recording drum 41, at a position immediately before the paper P is pressed by the pressing roller 42 (a position immediately before entering between the image recording drum 41 and the pressing roller 42), thereby applying a back tension to the paper P. This back tension application apparatus 300 suctions the upper surface of the paper P by the paper guide 310 and applies a back tension to the paper P. The paper guide 310 includes a guide surface on which the upper surface of the paper P slides, and suctions the upper surface of the paper P via the suction holes formed in the guide surface.

By applying a back tension to the paper P immediately before the paper P is pressed by the pressing roller 42, by means of the back tension application apparatus 300, it is possible to introduce the paper P in between the pressing roller 42 and the image recording drum 41 while stretching deformation (distortion) that has occurred in the paper P. By pressing the paper P with the pressing roller 42 which is formed in a crown shape, while applying a back tension to the paper P by the back tension application apparatus 300, it is possible to press the paper P in a tightly stretched state, and the paper P can be wrapped about the circumferential surface of the image recording drum 41 without giving rise to creasing or floating, right up to the corners of the paper P. In respect of this point, the specific composition of the back tension application apparatus 300 is described in detail hereinafter.

In the image recording unit 40 having the composition described above, the paper P is conveyed along a prescribed conveyance path by the image recording drum 41. The paper P transferred from the transfer drum 80 to the image recording drum 41 is firstly nipped by the paper pressing roller 42, while applying back tension by the back tension application apparatus 300, and is thereby caused to make tight contact with the outer circumferential surface of the image recording drum 41. Thereupon, the presence or absence of floating is detected by the paper floating detection sensor 43, whereupon ink droplets of respective colors of C, M, Y, K are ejected onto the printing surface from the inkjet heads 44C, 44M, 44Y, 44K, thereby forming a color image on the printing surface.

If floating of the paper P is detected, then conveyance is halted. By this means, the floating paper P can be prevented from contacting the nozzle surfaces of the inkjet heads 44C, 44M, 44Y, 44K.

As described above, in the inkjet recording apparatus 10 according to the present embodiment, aqueous ink is used for each of the colors. Even if using aqueous ink of this kind, since a treatment liquid is applied to the paper P as described above, then it is possible to carry out printing of high quality even if using generic printing paper.

The paper P on which an image has been printed is transferred to the transfer drum 90. Thereupon, the paper P is conveyed along the prescribed conveyance path by the transfer drum 90 and is transferred onto the conveyance drum 51 of the image drying unit 50.

Here, as described above, a drier 94 is arranged inside the transfer drum 90, and a warm air flow is blown toward the guide plate 92. An ink drying process is carried out in an ink drying unit 50 at a later stage, but the paper P also undergoes a drying process during conveyance by the transfer drum 90.

Although not shown in the drawings, a maintenance unit which performs maintenance of the inkjet heads 44C, 44M, 44Y, 44K is provided in the image recording unit 40, and the inkjet heads 44C, 44M, 44Y, 44K are moved to the maintenance unit as and when necessary so as to be able to receive required maintenance.

### (Ink Drying Unit)

The ink drying unit 50 dries the liquid component remaining on the paper P after image recording, This ink drying unit 50 principally includes a conveyance drum (hereinafter, called “ink drying drum”) 51 which conveys the paper P, and an ink drying apparatus 52 which carries out a drying process on the paper P conveyed by the ink drying drum 51.

The ink drying drum 51 receives paper P from the transfer drum 90 (by gripping the leading end of the paper P with a gripper G), and conveys the paper P along a prescribed conveyance path by rotating.

The ink drying apparatus 52 is constituted by a drier, for example, (in the present embodiment, the ink drying apparatus 52 is constituted by three driers which are arranged along the conveyance path of the paper P), and blows a warm air flow (for example, 80° C.) toward the paper P which is conveyed by the ink drying drum 51.

In the ink drying unit 50 having the composition described above, the paper P is conveyed along a prescribed conveyance path by the ink drying drum 51. During the course of this conveyance, a warm air flow is blown from the ink drying apparatus 52 onto the printing surface and the ink which has been deposited on the printing surface is dried (the solvent component is evaporated off).

The paper P which has passed through the ink drying apparatus 52 is subsequently received onto the transfer drum 100 from the ink drying drum 51 at a prescribed position. The paper P is conveyed on a prescribed conveyance path by the transfer drum 100 and is transferred to the conveyance drum 61 of the fixing unit 60.

As described above, a drier 104 is disposed inside the transfer drum 100 and blows a warm air flow toward the guide plate 102. Consequently, the paper P undergoes a drying process during conveyance on the transfer drum 100.

### (Fixing Unit)

The fixing unit 60 fixes the image which has been recorded on the printing surface, by applying heat and pressure to the paper P. The fixing unit 60 is principally constituted by a conveyance drum which conveys the paper P (hereinafter, called “fixing drum”) 61, an ultraviolet light irradiation light source 62 which directs an ultraviolet light beam onto the printing surface of the paper P, and an in-line sensor 64 which captures a printed image as well as determining a temperature and humidity, and the like, of the paper P after printing.

The fixing drum 61 receives paper P from the transfer drum 100 (by gripping the leading end of the paper P with a gripper G), and conveys the paper P along a prescribed conveyance path by rotating.

The ultraviolet light irradiation light source 62 solidifies an aggregate of the treatment liquid and the ink by irradiating ultraviolet light onto the printing surface of the paper P which is conveyed by the fixing drum 61.

The in-line sensor 64 includes a temperature meter, a humidity meter, and a CCD line sensor, and the like, and determines the temperature and humidity, and the like, of the paper P conveyed by the fixing drum 61, as well as reading the image printed on the paper P. Apparatus abnormalities and head ejection defects, and the like, are checked on the basis of the determination results of the in-line sensor 64.

In the fixing unit 60 having the composition described above, the paper P is conveyed along a prescribed conveyance path by the fixing drum 61. During the course of this conveyance, ultraviolet light is irradiated onto the printing surface from the ultraviolet light irradiation light source 62.

The paper P which has undergone a fixing process is transferred from the fixing drum 61 to the recovery unit 70 at a prescribed position.

### (Recovery Unit)

The recovery unit 70 recovers the paper P which has undergone the series of printing processes, in a stacked fashion in a stacker 71. The recovery unit 70 is principally constituted by a stacker 71 which recovers paper P, and a paper output conveyor 72 which receives paper P that has undergone a fixing process in the fixing unit 60, from the fixing drum 61, conveys the paper P on a prescribed conveyance path, and outputs the paper P to the stacker 71.

The paper P which has undergone a fixing process in the fixing unit 60 is transferred onto the paper output conveyor 72 from the fixing drum 61, conveyed by the paper output conveyor 72 up to the stacker 71, and then recovered in the stacker 71.

### ((Conveyance System))

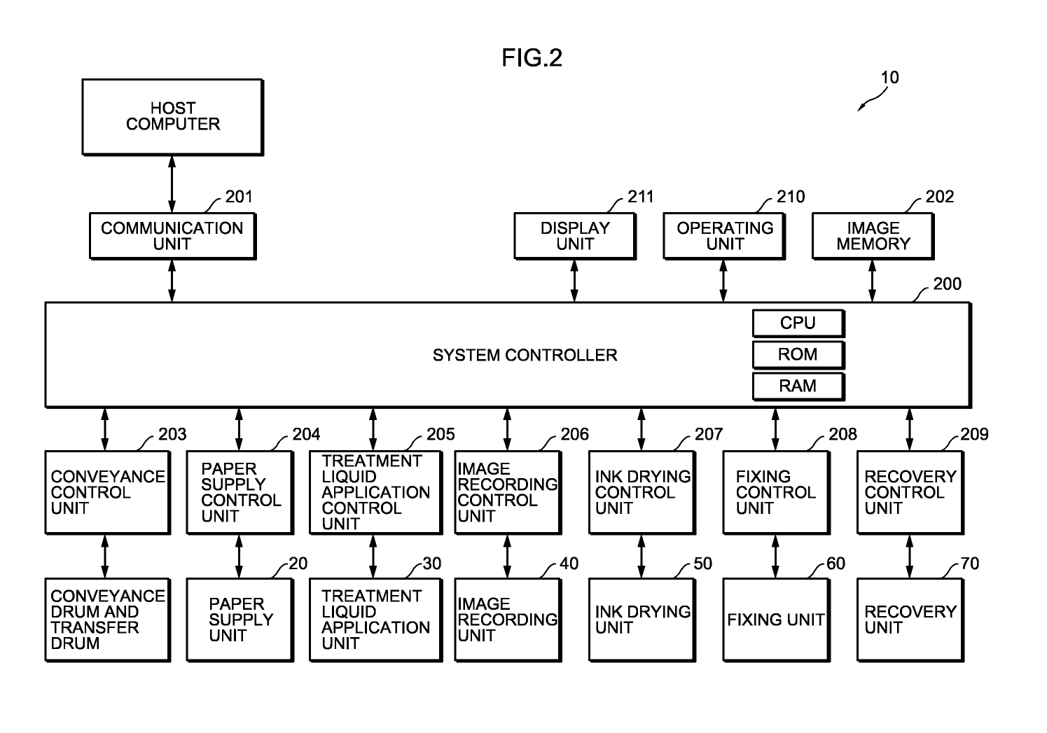

FIG. 2 is a block diagram showing the approximate composition of a conveyance system of an inkjet recording apparatus according to the present embodiment.

As shown in FIG. 2, the inkjet recording apparatus 10 includes a system controller 200, a communications unit 201, an image memory 202, a conveyance control unit 203, a paper supply control unit 204, a treatment liquid application control unit 205, an image recording control unit 206, an ink drying control unit 207, a fixing control unit 208, a recovery control unit 209, an operating unit 210, a display unit 211, and the like.

The system controller 200 functions as a control device which performs overall control of the respective units of the inkjet recording apparatus 10, and also functions as a calculation device which performs various calculation processes. This system controller 200 includes a CPU, ROM, RAM and the like, and operates in accordance with a prescribed control program. Control programs executed by the system controller 200 and various data necessary for control purposes are stored in the ROM.

The communications unit 201 includes a prescribed communications interface, and sends and receives data between the communications interface and a connected host computer.

The image memory 202 functions as a temporary storage device for various data including image data, and data is read from and written to the memory via the system controller 200. Image data which has been read in from a host computer via the communications unit 201 is stored in the image memory 202.

The conveyance control unit 203 controls the driving of the conveyance drums 31, 41, 51, 61 and the transfer drums 80, 90, 100, which are conveyance devices of the paper P in the treatment liquid application unit 30, the image recording unit 40, the ink drying unit 50 and the fixing unit 60.

More specifically, as well as controlling the driving of the motors which drive the conveyance drums 31, 41, 51, 61, the conveyance control unit 203 also controls the opening and closing of the grippers G which are provided on the conveyance drums 31, 41, 51, 61.

Similarly, the conveyance control unit 203 also controls the driving of the motors which drive the transfer drums 80, 90, 100, as well as controlling the opening and closing of the grippers G which are provided in the transfer drums 80, 90, 100.

Furthermore, since a mechanism for suctioning and holding the paper P on the circumferential surface is provided in each of the conveyance drums 31, 41, 51, 61, then the conveyance control unit 203 also controls the driving of the suctioning and holding mechanisms (in the present embodiment, since the paper P is suctioned by vacuum, then the conveyance control unit 203 controls the driving of the vacuum pump which forms a negative pressure generating device).

Moreover, driers 84, 94, 104 are provided in the transfer drums 80, 90, 100, and therefore the conveyance control unit 203 also controls the driving (amount of heating and air flow volume) of these driers.

The driving of the conveyance drums 31, 41, 51, 61 and the transfer drums 80, 90 100 is controlled in accordance with instructions from the system controller 200.

The paper supply control unit 204 controls the driving of the respective sections which constitute the paper supply unit 20 (the paper supply apparatus 21, transfer drum 23, and the like), in accordance with instructions from the system controller 200.

The treatment liquid application control unit 205 controls the driving of the respective sections which constitute the treatment liquid application unit 30 (the application apparatus 32, and the like), in accordance with instructions from the system controller 200.

The image recording control unit 206 controls the driving of the respective sections which constitute the image recording unit 40 (the pressing roller 42, the paper floating detection sensor 43, the inkjet heads 44C, 44M, 44Y, 44K, and the back tension application apparatus 300, and the like) in accordance with instructions from the system controller 200.

The ink drying control unit 207 controls the driving of the respective sections which constitute the ink drying unit 50 (the ink drying apparatus 52, and the like), in accordance with instructions from the system controller 200.

The fixing control unit 208 controls the driving of the respective sections which constitute the fixing unit 60 (the ultraviolet irradiation light source 62, the in-line sensor 64, and the like), in accordance with instructions from the system controller 200.

The recovery control unit 209 controls the driving of the respective sections which constitute the recovery unit 70 (the paper output conveyer 72, and the like), in accordance with instructions from the system controller 200.

The operating unit 210 includes a prescribed operating device (for example, operating buttons and a keyboard, a touch panel, or the like), and outputs operational information input from the operating device to the system controller 200. The system controller 200 executes various processing in accordance with the operational information input from the operating section 210.

The display unit 211 includes a prescribed display apparatus (for example, an LCD panel, or the like), and causes prescribed information to be displayed on the display apparatus in accordance with instructions from the system controller 200.

As described above, image data to be recorded on the paper is read into the inkjet recording apparatus 10 from the host computer via the communications unit 201 and is stored in the image memory 202. The system controller 200 generates dot data by carrying out prescribed signal processing on the image data stored in the image memory 202, and records an image represented by this image data by controlling the driving of the inkjet heads of the image recording unit 40 in accordance with the generated dot data.

In general, the dot data is generated by subjecting the image data to color conversion processing and halftone processing. The color conversion processing is processing for converting image data represented by sRGB, or the like (for example, RGB 8-bit image data) into ink volume data for each color of ink used by the inkjet recording apparatus 10 (in the present embodiment, ink volume data for the respective colors of C, M, Y, K). Halftone processing is processing for converting the ink volume data of the respective colors generated by the color conversion processing into dot data of respective colors by error diffusion processing, or the like.

The system controller 200 generates dot data of the respective colors by applying color conversion processing and halftone processing to the image data. An image represented by the image data is recorded on the paper by controlling the driving of the corresponding inkjet heads in accordance with the dot data for the respective colors thus generated.

### ((Printing Operation))

Next, a printing operation of the inkjet recording apparatus 10 described above will be explained.

When the system controller 200 outputs a paper supply instruction to the paper supply apparatus 21, paper P is supplied from the paper supply apparatus 21 to the paper supply tray 22. The paper P supplied to the paper supply tray 22 is transferred to the treatment liquid application drum 31 of the treatment liquid application unit 30 via the transfer drum 23.

The paper P transferred onto the treatment liquid application drum 31 is conveyed along a prescribed conveyance path by the treatment liquid application drum 31, and during the course of this conveyance, treatment liquid is deposited on the printing surface of the paper P by the application apparatus 32.

The paper P onto which treatment liquid has been applied is received onto the transfer drum 80 from the treatment liquid application drum 31. Thereupon, the paper P is conveyed along the prescribed conveyance path by the transfer drum 80 and is transferred onto the image recording drum 41 of the image recording unit 40. During the course of conveyance of the paper P by the transfer drum 80, a warm air flow is blown onto the printing surface from the drier 84 which is disposed inside the transfer drum 80, and the treatment liquid which has been applied to the printing surface is dried.

The paper P transferred from the transfer drum 80 to the image recording drum 41 is firstly nipped by the pressing roller 42 and the rear surface of the paper P is caused to make tight contact with the outer circumferential surface of the image recording drum 41.

The presence or absence of floating in the paper P which has passed the pressing roller 42 is then detected by the paper floating detection sensor 43. If floating of the paper P is detected, the conveyance of the paper P is halted. On the other hand, if floating is not detected, then the paper P is conveyed directly to the inkjet heads 44C, 44M, 44Y, 44K. Thereupon, when the paper P passes below the inkjet heads 44C, 44M, 44Y, 44K, ink droplets of the respective colors of C, M, Y, K are ejected from the inkjet heads 44C, 44M, 44Y, 44K, and a color image is thereby formed on the printing surface.

The paper P on which an image has been formed is received onto the transfer drum 90 from the image recording drum 41. Thereupon, the paper P is conveyed along the prescribed conveyance path by the transfer drum 90 and is transferred onto the ink drying drum 51 of the image drying unit 50. During the course of conveyance of the paper P by the transfer drum 90, a warm air flow is blown onto the printing surface from the drier 94 which is disposed inside the transfer drum 90, and the ink which has been deposited on the printing surface is dried.

The paper P which has been transferred to the ink drying drum 51 is conveyed along the prescribed conveyance path by the ink drying drum 51. During the course of this conveyance, a warm air flow is blown from the ink drying apparatus 52 onto the printing surface and the liquid component remaining on the printing surface is dried.

The paper P which has undergone a drying process is transferred from the ink drying drum 51 to the transfer drum 100. The paper P is conveyed on a prescribed conveyance path by the transfer drum 100 and is transferred to the fixing drum 61 of the fixing unit 60. During the course of conveyance of the paper P by the transfer drum 100, a warm air flow is blown onto the printing surface from the drier 104 which is disposed inside the transfer drum 100, and the ink which has been deposited on the printing surface is dried further.

The paper P which has been transferred to the fixing drum 61 is conveyed along a prescribed conveyance path by the fixing drum 61. Ultraviolet light is irradiated onto the printing surface during the conveyance of this conveyance, and the image formed on the paper P is fixed. The paper P is then transferred onto the paper output conveyor 72 of the recovery unit 70 from the fixing drum 61, conveyed by the paper output conveyor 72 up to the stacker 71, and then output into the stacker 71.

As described above, in the inkjet recording apparatus 10 according to the present embodiment, the paper P is conveyed on drums and during the course of this conveyance, respective processes of application and drying of treatment liquid, ejection and drying of ink droplets, and fixing, are carried out on the paper P, thereby recording a prescribed image on the paper P.

### ((Detailed Description of Paper Conveyance Mechanism in Image Recording Unit))

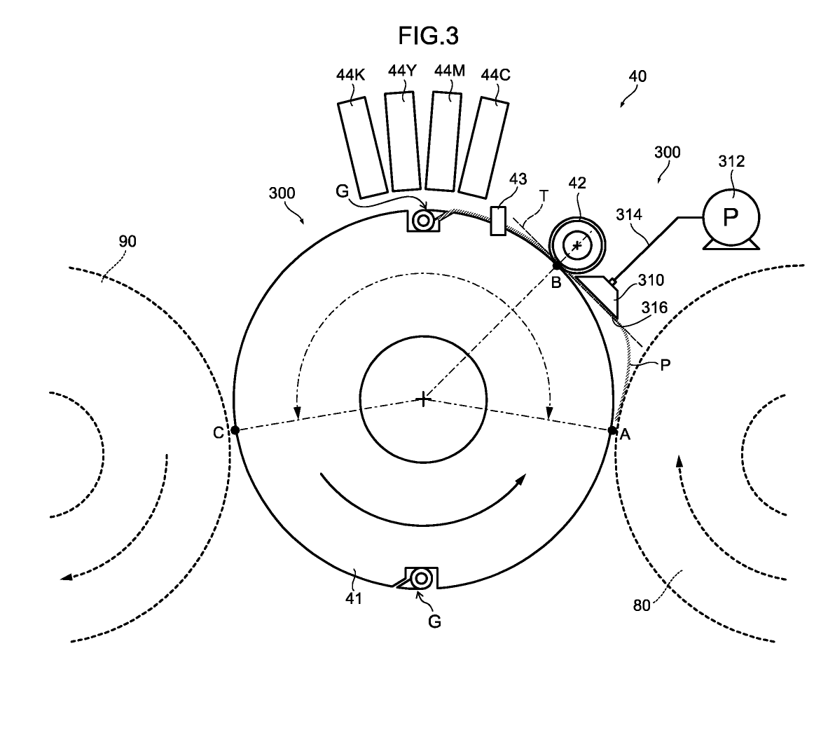

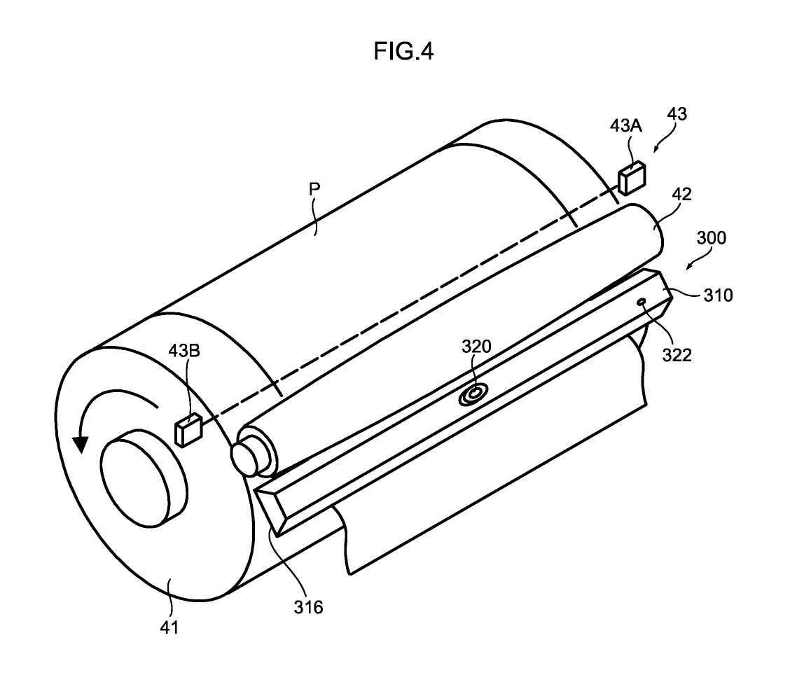

FIG. 3 is a side view diagram showing the general composition of a paper conveyance mechanism in an inkjet recording apparatus. Furthermore, FIG. 4 is a perspective diagram showing the general composition of a paper conveyance mechanism in an image recording apparatus.

As described previously, the image recording unit 40 is constituted by an image recording drum 41 which conveys the paper P, a pressing roller 42 which nips the paper P conveyed on the image recording drum 41 and causes the paper P to make tight contact with the circumferential surface of the image recording drum 41, a paper floating detection sensor 43 which detects floating of the paper P conveyed by the image recording drum 41, inkjet heads 44C, 44M, 44Y, 44K which eject ink droplets onto the paper P which is conveyed by the image recording drum 41, and a back tension application device 300 which applies a back tension to the paper P by suctioning the front surface (printing surface) of the paper P at a position immediately before the pressing roller 42.

The image recording drum 41 receives the paper P conveyed by the transfer drum 80, at a prescribed receiving position A, and conveys the paper P along a circular arc-shaped conveyance path by rotating about an axle. In this, the paper P is conveyed while being suctioned and held on the outer circumferential surface of the image recording drum 41. In other words, a plurality of suction holes are formed in a uniform pattern on the circumferential surface of the image recording drum 41, and by suctioning air from the interior of the drum via these suction holes, the paper P which is wrapped about the outer circumferential surface is suctioned and held.

In the image recording drum 41 according to the present embodiment, the operating range of suctioning is limited, and suctioning is carried out only in a range from a prescribed suctioning start position B to a suctioning end position C. Here, the suctioning start position B is set to a position which is separated by a prescribed distance from the receiving position A (a position after rotation through a prescribed angle), and the suctioning end position C is set to a position where paper P is transferred onto the transfer drum 90. Consequently, the paper P starts to be suctioned after having been conveyed through a prescribed distance from the receiving position A.

As shown in FIG. 4, the pressing roller 42 is arranged to the upstream side of the inkjet heads in terms of the conveyance direction of the paper P. In the present embodiment, the pressing roller 42 is arranged at the suctioning start position B.

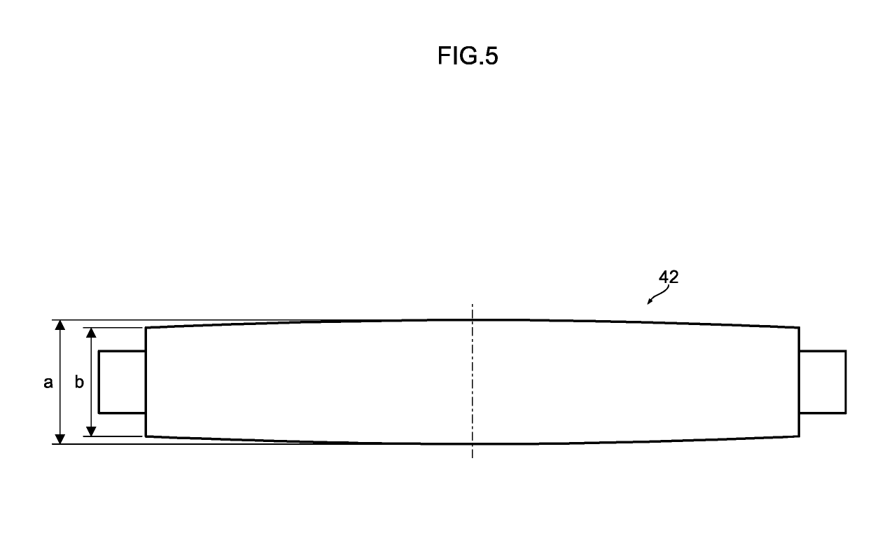

The pressing roller 42 is constituted by a rubber roller having a width that is substantially the same as the width of the image recording drum 41 (here, a roller formed by applying a rubber coating about the periphery of a metal core material (axle portion)), and as shown in FIG. 5, the pressing roller 42 is formed to a shape in which the outer diameter becomes smaller from the center towards either end (and in particular, a shape in which the outer shape becomes smaller so as to form a circular arc shape). In other words, the roller is formed in a so-called crown shape.

The pressing roller 42 is arranged in parallel with the image recording drum 41 (in perpendicular with the conveyance direction of the paper P), and either end of the axle portion thereof is held and supported rotatably by a bearing (not illustrated). The bearings are impelled towards the image recording drum 41 by an impelling mechanism (for example, a spring) (not illustrated) with a prescribed impelling force. By this means, the pressing roller 42 is pressed and abutted against the outer circumferential surface of the image recording drum 41 with a prescribed pressing force. Furthermore, as a result of this, when the image recording drum 41 rotates, the pressing roller 42 rotates in conjunction with the rotation of the image recording drum 41 (so-called joint rotation).

When the paper P which has been transferred to the image recording drum 41 at the receiving position is conveyed to the suctioning start position B, the paper P is nipped by the pressing roller 42 and is caused to make tight contact with the outer circumferential surface of the image recording drum 41. Furthermore, simultaneously with this, suctioning is started.

The paper floating detection sensor 43 detects floating of the paper P passing the pressing roller 42. Consequently, the paper floating detection sensor 43 is provided after the pressing roller 42 (to the downstream side of the pressing roller 42 in terms of the conveyance direction of the paper P by the image recording drum 41).

As shown in FIG. 4, the paper floating detection sensor 43 is constituted by a laser emitter 43A which emits laser light and a laser receiver 43B which receives the laser light.

The laser emitter 43A emits laser light parallel to the axis of the image recording drum 41, from one end of the image recording drum 41 toward the other end thereof in the width direction, at a position a prescribed height above the outer circumferential surface of the image recording drum 41 (namely, a position at the height of the upper limit of the permissible range of floating).

The laser receiver 43B is arranged opposing the laser emitter 43A on the other side of the path of travel of the paper P by the image recording drum 41, and receives laser light emitted by the laser emitter 43A. The laser receiver 43B determines the amount of laser light received, and outputs this determination result to the system controller 200.

The system controller 200 detects floating of the paper P on the basis of the obtained information about the amount of received light. More specifically, when floating equal to or exceeding a permissible value has occurred in the paper P, then the laser light emitted from the laser emitter 43A is blocked by the paper P. As a result of this, the amount of laser light received by the laser receiver 43B declines. More specifically, system controller 200 compares the amount of laser light received by the laser receiver 43B with a threshold value, and judges that floating (floating equal to or exceeding a permissible value) has occurred if the amount of laser light received is equal to or less than the threshold value. By this means, it is possible to detect floating of the paper P.

The system controller 200 halts rotation of the image recording drum 41 and halts the conveyance of the paper P, if floating equal to or exceeding the permissible value is detected. By this means, the floating paper P can be prevented from making contact with the nozzle surfaces of the inkjet heads.

The paper floating detection sensor 43 is composed in such a manner that the height at which the laser light is emitted from the laser emitter 43A and received by the laser receiver 43B (the height of the laser light from the outer circumferential surface of the image recording drum 41) can be adjusted. Consequently, the permissible range of floating can be set as desired, in accordance with the thickness of the paper P, and the like.

The height of the emitted and received laser light is adjusted by changing the height at which the laser emitter 43A and the laser receiver 43B are installed. Apart from this, it is also possible to adjust the height of the emitted and received laser light through refraction, by providing a transparent parallel plate (for example, a glass parallel plate) having an adjustable angle, in front of the laser emitter 43A and the laser receiver 43B (if the transparent parallel plate is arranged perpendicularly with respect to the laser light, then the laser light travels straight on, but if the parallel plate is provided at an inclination with respect to the light, then the light is diffracted upon entering and exiting the plate, and hence the height can be adjusted).

Furthermore, by providing an aperture in front of the laser emitter 43A and the laser receiver 43B, it is possible to eliminate unwanted light, and more accurate detection can be performed.

As shown in FIG. 3, the back tension application apparatus 300 suctions the upper surface of the paper P conveyed by the image recording drum 41, at a position immediately before the paper P is pressed by the pressing roller 42 (a position immediately before entering between the image recording drum 41 and the pressing roller 42), thereby applying a back tension to the paper P.

The back tension application apparatus 300 is principally constituted by a paper guide 310 and a vacuum pump 312.

The paper guide 310 is formed in a hollow box shape having a trapezoidal cross-section parallel to the conveyance direction of the paper P (a divergent box shape), and is formed so as to correspond to the paper width. Therefore, the width (the width in the direction perpendicular to the conveyance direction of the paper P) is formed to be substantially the same as the width of the image recording drum 41.

The surface of the paper guide 310 on the image recording drum side (the lower surface) suctions the front surface (printing surface) of the paper P, and furthermore, is formed in a flat shape so as to act as a guide surface 316 for the travel of the paper P.

The paper guide 310 is provided in the vicinity of the pressing roller 42, and the guide surface 316 is arranged so as to follow a tangent T to the image recording drum 41 at the installation point of the pressing roller 42 (the point of contact between the pressing roller 42 and the outer circumferential surface of the image recording drum 41 (in the present embodiment, the suctioning start position B)) (in other words, the guide surface 316 is arranged in such a manner that the installation point of the pressing roller 42 is situated on the extension line of the guide surface 316).

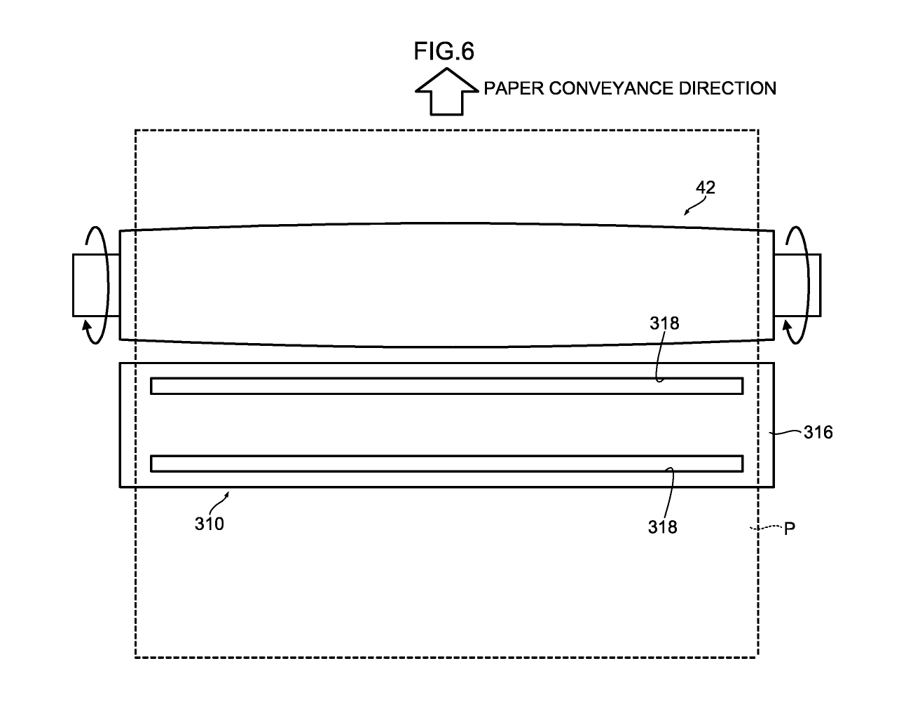

FIG. 6 is a lower surface diagram of the paper guide (a plan diagram of the guide surface). As shown in FIG. 6, suction holes 318 are formed in the guide surface 316. The suction holes 318 are formed in a slit shape and are formed in a direction perpendicular to the conveyance direction of the paper P (namely, in parallel with the axis of the pressing roller 42). The suction holes 318 are connected to the interior (hollow portion) of the paper guide which is formed in a hollow centered shape.

The number of suction holes 318 is not limited in particular. The number of suction holes 318 is set appropriately in accordance with the length of the guide surface 316 in the front/rear direction (the conveyance direction of the paper P), and the like. In the present embodiment, two suction holes 318 are formed at the front and rear of the conveyance direction of the paper P.

A suction hole 320 is formed in a central portion of the upper surface of the paper guide 310 (the surface opposite to the guide surface 316). The suction hole 320 is connected to the interior (hollow portion) of the paper guide 310 which is formed in a hollow centered shape. By suctioning air from the suction hole 320, air is suctioned from the suction holes 318 which are formed in the guide surface 316.

Furthermore, a vacuum prevention hole 322 is formed in the upper surface of the paper guide 310. The vacuum prevention hole 322 prevents the application of excessive suction force by allowing the pressure inside the paper guide 310 to escape. Since the vacuum prevention hole 322 serves to prevent the application of an excessive suction force in this way, then the position, size and number thereof are adjusted appropriately within a range meeting this object.

The vacuum pump 312 is connected to the suction port 320 of the paper guide 310 via a suction pipe 314. By driving the vacuum pump 312, the interior of the paper guide 310 (the hollow center portion) is suctioned and air is suctioned from the suction hole 318 formed in the guide surface 316. The driving of the vacuum pump 312 is controlled by the controller 200 via the image recording control unit 206.

The back tension application apparatus 300 is composed as described above.

### ((Action of Paper Conveyance Mechanism in Image Recording Unit))

As described above, the paper P is received onto the image recording drum 41 from the transfer drum 80. The image recording drum 41 receives the paper P from the transfer drum 80 at a prescribed receiving position A.

The paper P is received by gripping the leading end of the paper P with a gripper G. The image recording drum 41 receives the paper P while rotating.

The paper P of which the leading end has been gripped by the gripper G is conveyed by rotation of the image recording drum 41. The surface (printing surface) is then pressed by the pressing roller 42 at the position where the pressing roller 42 is installed, thereby causing the paper P to make tight contact with the outer circumferential surface of the image recording drum 41.

Here, a paper guide 310 is provided before the pressing roller 42 (the upstream side of the pressing roller in the conveyance direction of the paper P), in the inkjet recording apparatus 10 according to the present embodiment.

The guide surface 316 of the paper guide 310 is provided at a separation from the outer circumference of the image recording drum 41, but air is suctioned from the suction holes 318 formed in the guide surface 316 (the vacuum pump 312 is driven) simultaneously with the operation of the inkjet recording apparatus 10. As a result of this, the front surface (printing surface) of the paper P which is conveyed by the image recording drum 41 is suctioned to the suction holes 318 at a position immediately before the paper P is pressed by the pressing roller 42, thereby suctioning the front surface of the paper P to the guide surface 316. Consequently, a back tension is applied to the paper P which advances in between the pressing roller 42 and the image recording drum 41. By applying this back tension, the paper P is stretched in the conveyance direction and deformation (distortion) occurring in the paper P is removed.

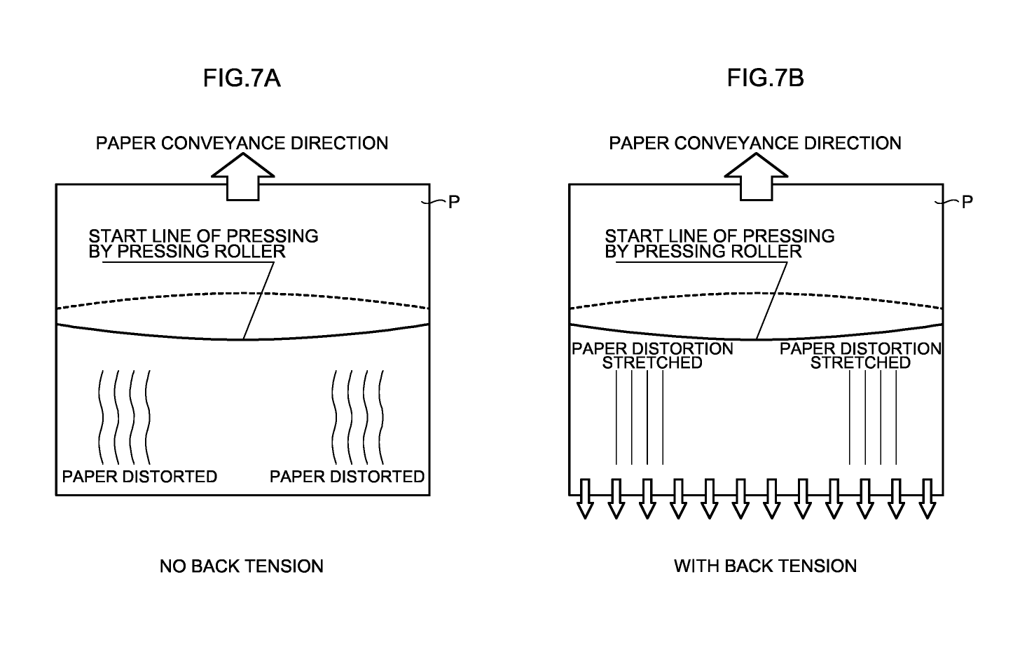

In other words, when a back tension is not applied, as shown in FIG. 7A, the paper P still retains deformation when introduced in between the pressing roller 42 and the image recording drum 41. On the other hand, as shown in FIG. 7B, by applying a back tension, the paper P is stretched in the conveyance direction, and the deformation (distortion) is removed from the paper P when introduced in between the pressing roller 42 and the image recording drum 41.

The front surface of the paper P which is introduced between the pressing roller 42 and the image recording drum 41 in a state where a back tension is applied by the paper guide 310 is pressed by the pressing roller 42 and makes tight contact with the outer circumferential surface of the image recording drum 41.

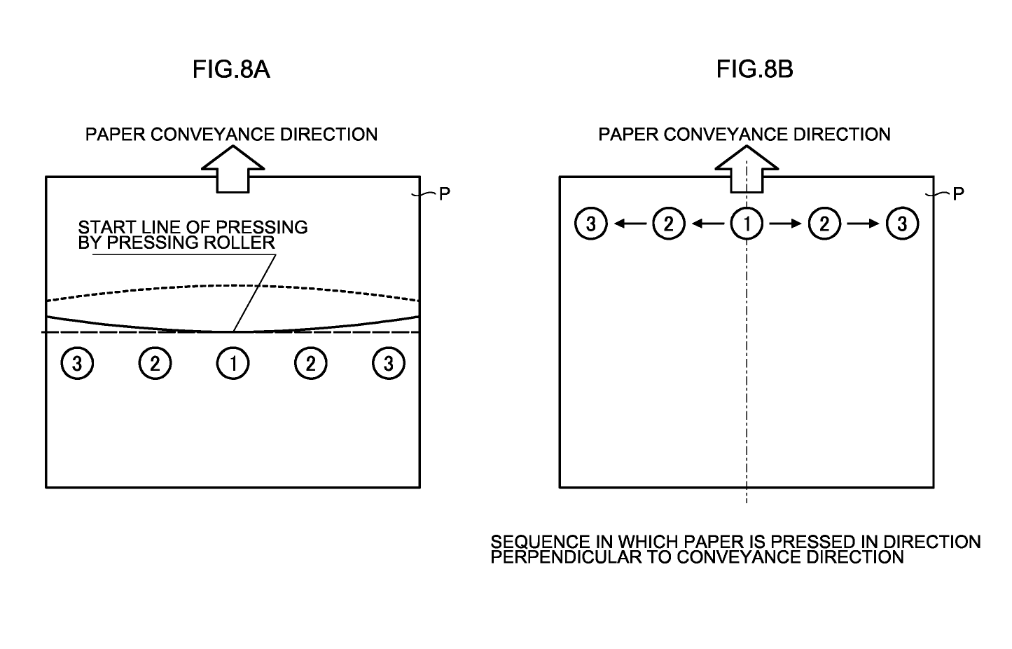

Here, the pressing roller 42 according to the present embodiment is formed in a shape whereby the outer diameter becomes smaller from the center towards either end (a so-called crown shape), and therefore it is possible to press the paper P while stretching the paper P in the width direction (the direction perpendicular to the conveyance direction). FIGS. 8A and 8B are diagrams which illustrate this mechanism. By pressing the paper P with the pressing roller 42 which is formed in a so-called crown shape, the paper P makes contact with a pressing roller 42 starting from the central portion, as shown in FIG. 8A. Therefore, as shown in FIG. 8B, the paper P is pressed successively from the central portion to the outer sides (when viewed in a cross-section perpendicular to the conveyance direction, the paper P is pressed successively from the central portion towards the outer sides). (In other words, the roller is pressed successively in the sequence of reference numerals 1→2→3 in FIG. 8B). Consequently, the paper P is pressed while being stretched towards either side in the width direction (the paper P is stroked towards either side in the width direction). Therefore, it is possible to press the paper P against the front surface of the image recording drum 41 while stretching the deformation (distortion) of the paper P in the width direction.

As described above, the paper P is introduced in between the pressing roller 42 and the image recording drum 41, while a back tension is applied thereto. Due to the action of this back tension, the paper P is introduced in between the pressing roller 42 and the image recording drum 41 while being stretched in the conveyance direction. Furthermore, the paper P is pressed against the circumferential surface of the image recording drum 41 while the paper P is stretched in the width direction by the pressing roller 42. In this way, the paper P can be wrapped about the circumferential surface of the image recording drum 41 without the occurrence of creasing or floating, even in the corners of the paper P, due to the combined effects of the action of the back tension and the action of the pressing roller 42. In particular, the paper P can be caused to make tight contact with the circumferential surface of the image recording drum 41, without the occurrence of creasing or floating in the respective end portions of the paper P in the width direction, in the trailing end portion of the paper P.

Since the image recording drum 41 performs a suctioning operation from the installation point of the pressing roller 42, then the rear surface of the paper P is suctioned from the suction holes formed in the outer circumferential surface of the image recording drum 41, simultaneously with being pressed by the pressing roller 42, and the paper P is suctioned and held on the outer circumferential surface of the image recording drum 41.

The paper P then passes the paper floating detection sensor 43 and the presence or absence of floating is detected, whereupon the paper P passes the installation positions of the inkjet heads 44C, 44M, 44Y, 44K, whereby an image is recorded on the front surface of the paper P.

As described above, according to the paper conveyance mechanism of the present embodiment, a back tension is applied to the paper P and furthermore, the paper P is pressed by the pressing roller 42 which is formed in a so-called crown shape and is caused to make tight contact with the circumferential surface of the image recording drum 41. By this means, the paper P can be wrapped about the circumferential surface of the image recording drum 41 without the occurrence of creasing or floating, even in the corners of the paper P, due to the combined effects of the action of the back tension and the action of the pressing roller 42 which is formed in a so-called crown shape. Consequently, the paper P can be conveyed stably, and an image of high quality can be recorded in a stable fashion.

Moreover, in the present embodiment, since the guide surface 316 is arranged so as to follow a tangent T to the image recording drum 41 at the installation point of the pressing roller 42, then it is possible to introduce the paper P smoothly in between the pressing roller 42 and the image recording drum 41.

Furthermore, in the paper conveyance mechanism according to the present embodiment, since the rear surface of the paper P is suctioned, then even if an image has already been recorded on the rear surface of the paper P which is the object of the printing process, for example, it is possible to convey the paper P without damaging the image.

Desirably, the pressing roller 42 is set so as to make contact with the whole region of the paper P in the width direction and press the paper P. Therefore, the pressing roller 42 is pressed against the paper P under conditions (a pressing force (nip force)) which enable the roller to make contact with the whole region of the paper P in the width direction. Furthermore, the pressing roller 42 is also formed under conditions which enable the roller to make contact with the whole region of the paper P in the width direction (amount of elastic deformation of the rubber, outer diameter differential, etc.). By this means, it is possible to prevent the occurrence of creasing or floating, more reliably.

The force which pulls the paper P in the width direction (tension in the width direction) can be raised by increasing the outer diameter differential of the pressing roller 42.

In this case, if the outer diameter of the central portion is a and the outer diameter of the respective end sections is b (see FIG. 5), then it is desirable to form the roller so as to satisfy the condition 0≦a-b≦4t (where t is the paper thickness), taking account of the amount of elastic deformation of the rubber.

Furthermore, desirably, the circumferential surface of the pressing roller 42 is smooth and free from step differences and is formed (in a circular arc shape) so as to have a prescribed curvature. By this means, it is possible to prevent the occurrence of creasing or floating, more reliably.

As described above, the pressing roller 42 can adjust the force which pulls the paper P in the width direction, by altering the outer diameter differential thereof. Consequently, it is desirable to adjust the shape and pressing force in accordance with the type of paper P, and the like. In this case, desirably, a plurality of pressing rollers having different shapes (outer diameter differentials) are prepared in advance, in such a manner that the pressing roller can be exchanged as appropriate. Furthermore, desirably, a mechanism for adjusting the pressing force (for example, an impelling mechanism capable of adjusting the impelling force, or the like) is provided, in such a manner that the pressing force can be adjusted.

### ((Further Mode of the Pressing Roller))

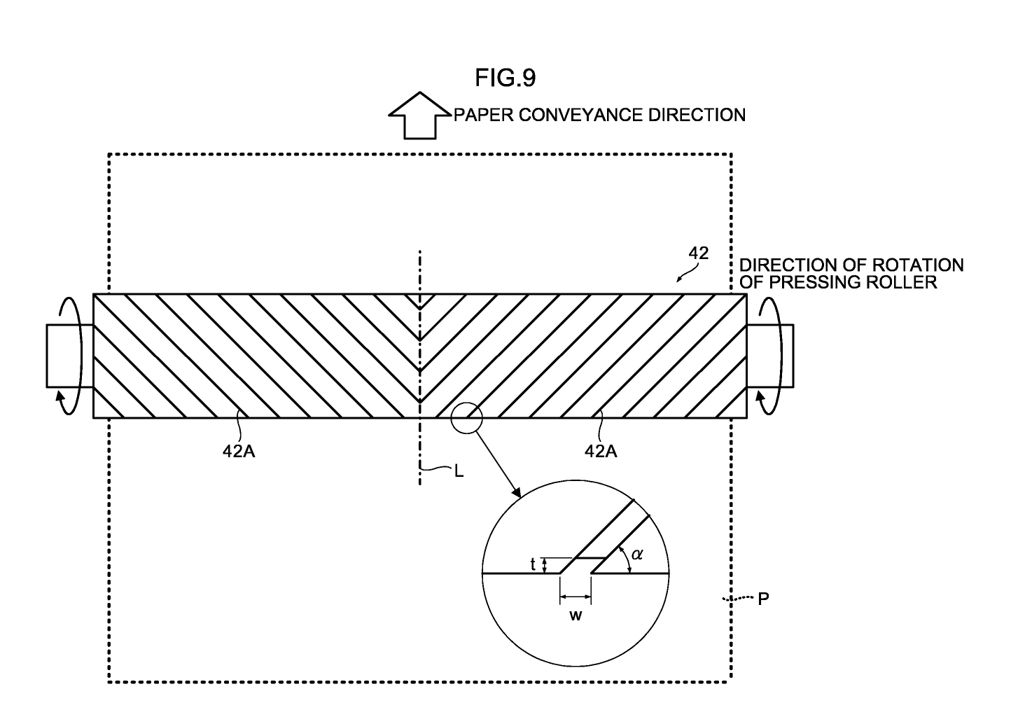

FIG. 9 is a plan diagram showing a further mode of a pressing roller.

As shown in FIG. 9, the pressing roller 42 according to the present embodiment is formed in such a manner that the whole region in the width direction has the same diameter (namely, a round cylindrical shape), and spiral grooves 42A are formed from the center towards the outer sides in the circumferential surface of the roller.

Here, the grooves 42A are formed in left/right symmetry about the center of the pressing roller 42 in the width direction (namely, the grooves are formed in left/right symmetry with respect to a straight line L which passes through the center of the roller in the width direction (the straight line L being perpendicular to the axis of rotation of the pressing roller 42)).

Furthermore, the grooves 42A are formed so as to face inwards with respect to the direction of rotation of the pressing roller 42. In other words, the grooves 42A are formed so as to face from the upstream side towards the downstream side in the direction of rotation of the pressing roller 42, and so as to be directed towards the center of the pressing roller 42 in the width direction (a position of a groove on the downstream side is set closer to the center of the pressing roller 42 in the width direction, with respect to a position of a groove on the upstream side).

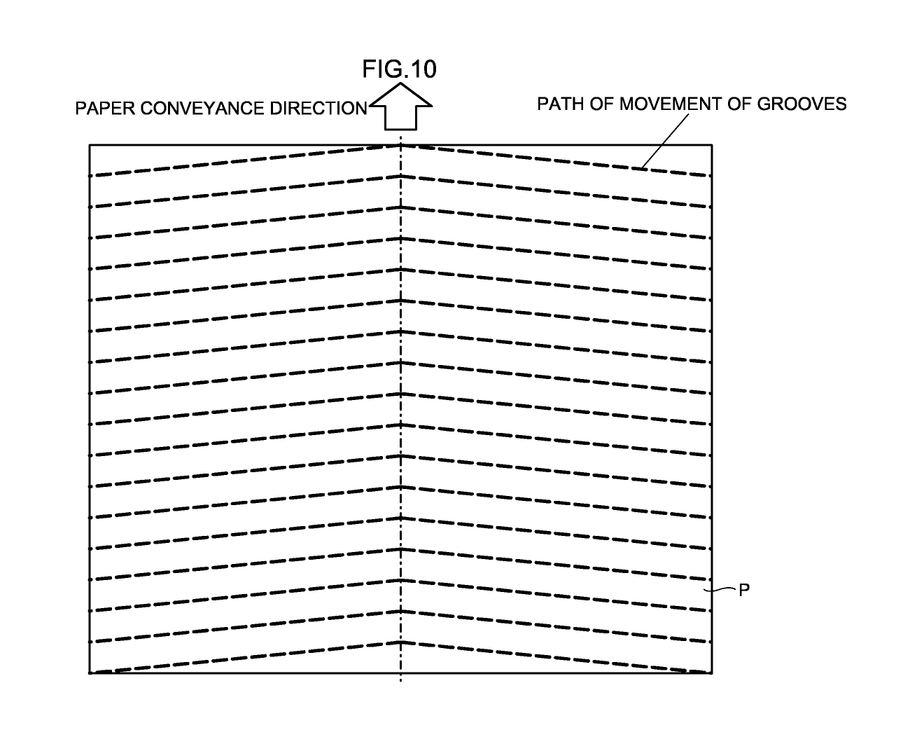

The pressing roller 42 formed in this way rotates in accordance with the travel of the paper P (joint rotation), upon being pressed against the paper P on the image recording drum. FIG. 10 is a diagram showing a relative movement path of the grooves 42A with respect to the paper P (a diagram showing the path of travel of the grooves 42A upon passing over the paper P). As shown in FIG. 10, the grooves 42A move from the central portion in the width direction towards the rear outer sides with respect to the paper P. Due to the grooves 42A moving from the central portion of the width direction towards the rear outer side with respect to the paper P, it is possible to produce a stroking action on the paper P, from the central portion towards the rear outer sides (the paper P is stroked by the edge portions of the grooves 42A), and deformation (distortion) occurring in the paper P can be eliminated in the width direction. In other words, it is possible to achieve similar beneficial effects to those of the crown-shaped pressing roller described above.

In the pressing roller 42, the stroking force acting on the paper P in the width direction can be regulated by adjusting the angle of inclination a of the spiral grooves 42A which are formed in the circumferential surface (the angle between the spiral grooves 42A and a straight line parallel to the axis of rotation of the pressing roller 42). In other words, by adjusting this angle of inclination a, it is possible to adjust the size of the creases, and the like, that are removed.

Consequently, it is desirable to prepare a plurality of pressing rollers 42 having different angles of inclination α, in advance, in such a manner that the pressing roller can be exchanged appropriately.

There are no particular restrictions on the depth t or width w of the grooves 42A, but desirably, the grooves 42A are formed so as to be able to nip the whole surface of the paper P at the prescribed pressing force, and preferably the depth is no more than 2 mm and the width is no more than 10 mm.

### ((Further Modes of Paper Guide))

### (Further Modes of Guide Surface)

In the mode described above, the shape of the guide surface 316 of the paper guide 310 is flat, but the shape of the guide surface 316 is not limited to this. Below, a further mode of the guide surface 316 of the paper guide 310 will be described.

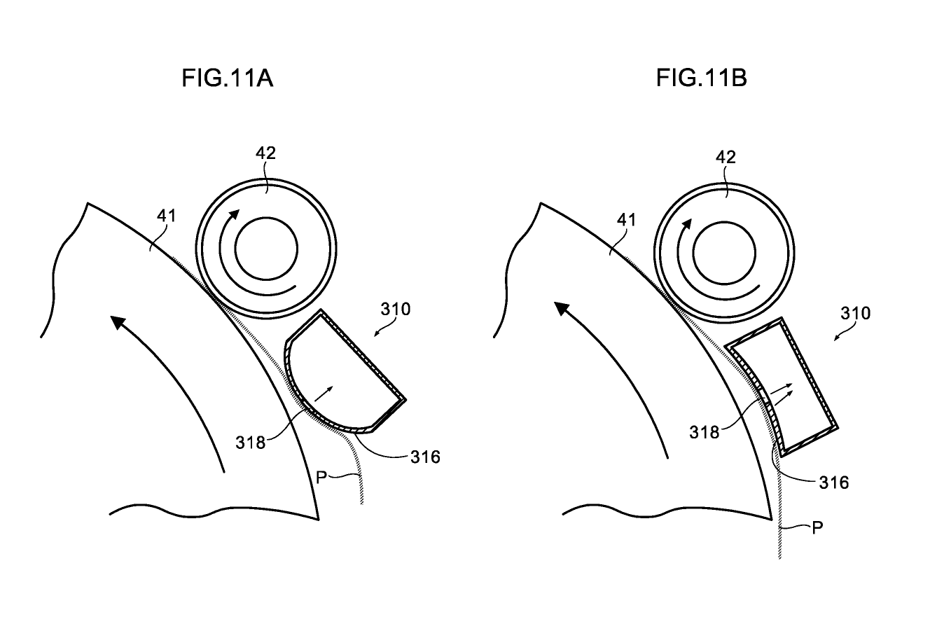

FIGS. 11A and 11B are diagrams showing a further mode of the guide surface of the paper guide.

FIG. 11A shows the cross-sectional shape of the guide surface 316 in the front/rear direction (the direction parallel to the conveyance direction of the paper P) as a circular arc shape which projects towards the image recording drum 41.

FIG. 11B shows the cross-sectional shape of the guide surface 316 in the front/rear direction (the direction parallel to the conveyance direction of the paper P) as a circular arc shape which is recessed towards the image recording drum 41.

By forming the guide surface 316 with a circular arc shape in a cross-section in the direction parallel to the conveyance direction of the paper P, it is possible to raise the contact surface area of the paper P. Consequently, it is possible to raise the suction holding force, as well as being able to guide the paper P in a stable fashion.

In the example shown in FIGS. 11A and 11B, a suction hole 318 is formed only in the center of the guide surface 316 in the front/rear direction, but it is also possible to form a plurality of suction holes 318 along the front/rear direction. By this means, it is possible to raise the contact surface area yet further.

Moreover, the curvature of the circular arc is set by taking account of the installation position of the paper guide 310, and the like, and is desirably set so as to be able to guide the paper P readily between the pressing roller 42 and the image recording drum 41.

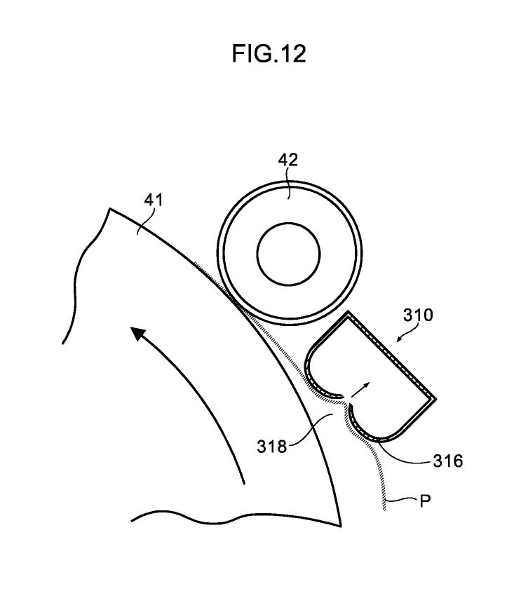

FIG. 12 is a diagram showing yet a further mode of the guide surface of the paper guide.

As shown in FIG. 12, the guide surface 316 has a wave-shaped cross-sectional form in the front/rear direction (the direction parallel to the conveyance direction of the paper P), and a suction hole 318 is formed in the valley portion of this wave shape.

By forming the guide surface 316 in this way, the paper P bends so as to be pulled towards the valley portion and therefore the suction holding force can be raised yet further.

In this case, the suction hole 318 formed in the valley portion may be formed in a slit shape, and may be formed at a uniform pitch along the valley portion as round holes or oval holes.

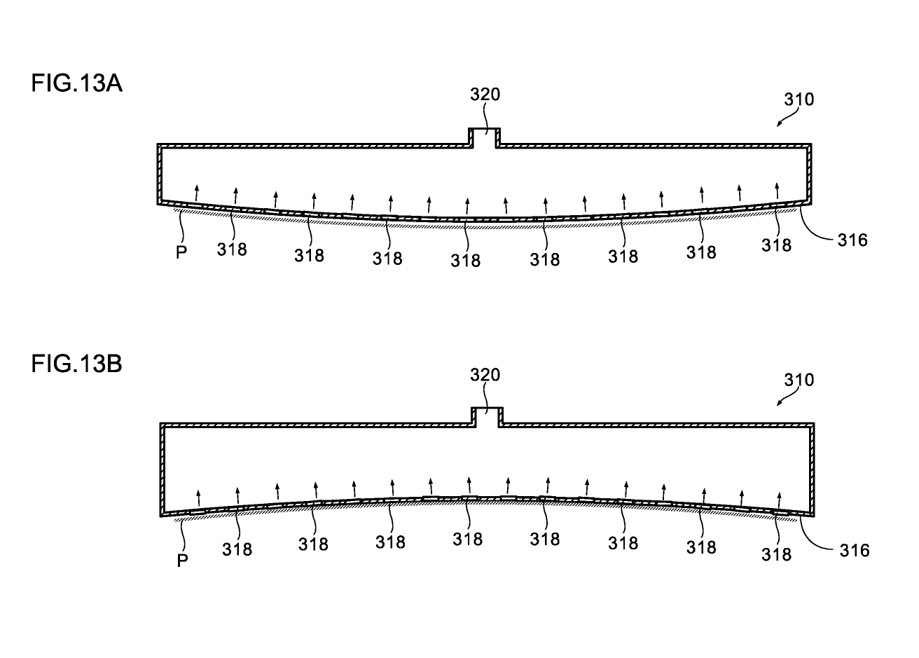

FIGS. 13A and 13B are diagrams showing yet a further mode of the guide surface of the paper guide.

FIG. 13A shows the cross-sectional shape of the guide surface 316 in the width direction (the direction perpendicular to the conveyance direction of the paper P) as a circular arc shape which projects towards the image recording drum 41.

FIG. 13B shows the cross-sectional shape of the guide surface 316 in the width direction (the direction perpendicular to the conveyance direction of the paper P) as a circular arc shape which is recessed towards the image recording drum 41.

In this way, by making the cross-sectional shape of the guide surface 316 in the direction perpendicular to the conveyance direction of the paper P a circular arc shape in this way, the paper P follows a direction that bends the paper P, compared to the case of a flat shape, and therefore it is possible to prevent slackness of the paper P. By this means, it is possible to prevent the occurrence of creasing caused by pressing by the pressing roller 42, more effectively. Furthermore, as shown in FIG. 13A, by forming the guide surface 316 in a circular arc shape which projects towards the image recording drum 41, it is possible to cause the paper P to make tight contact with the image recording drum 41, successively, from the center towards either end, and hence the occurrence of creasing can be prevented even more effectively.

It is also possible to form the shape of the cross-section in the direction perpendicular to the conveyance direction of the paper P, as a circular arc shape, and to form the shape of the cross-section in the direction parallel to the conveyance direction of the paper P in a circular arc shape or a wave shape. By this means, it is possible to obtain the beneficial effects of both.

Desirably, the most appropriate shape of the guide surface 316 is selected in accordance with the type and thickness of the paper P used, and the like.

### (Further Modes of Suction Hole)

In the mode described above, the shape of the suction hole 318 which is formed in the guide surface 316 is a slit shape, which is formed so as to be perpendicular to the conveyance direction of the paper P. The suction hole 318 having a shape of this kind can suction the paper P continuously in the width direction and hence a high holding force can be obtained.

The shape of the suction hole 318 can adopt various modes, and desirably, the most appropriate shape of the suction hole 318 is selected in accordance with the type and thickness of the paper P used, and the like. Below, another mode of the suction hole 318 formed in the guide surface 316 will be described.

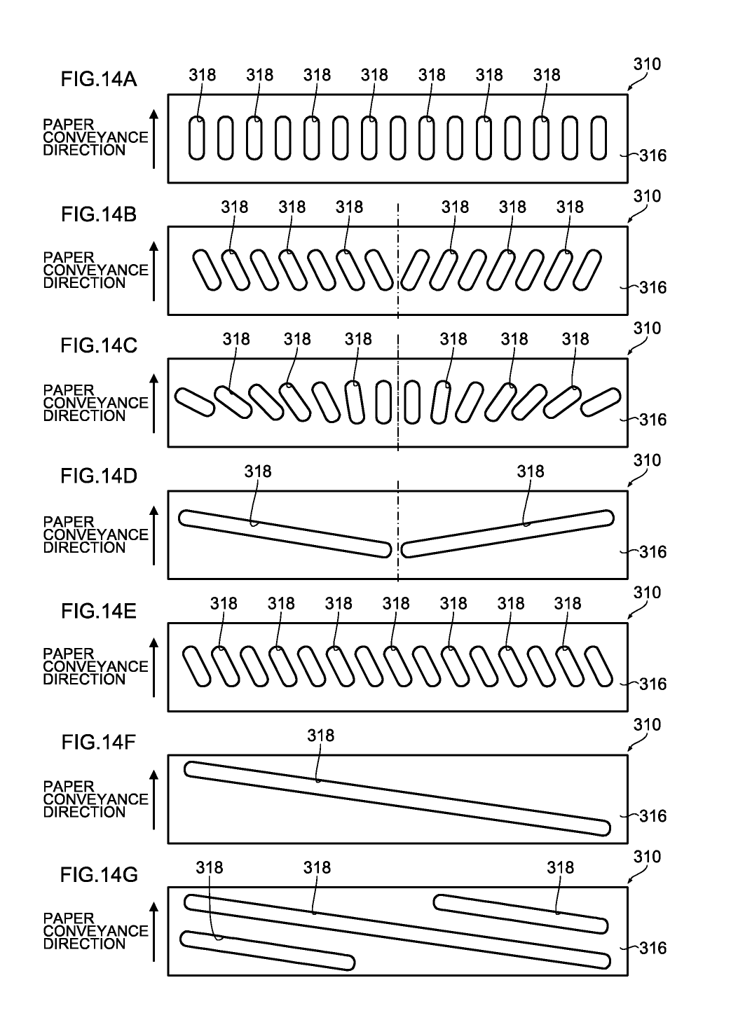

FIGS. 14A to 14G are diagrams showing a further mode of the suction hole formed in the guide surface.

FIG. 14A shows a case where a plurality of suction holes 318 are formed at uniform intervals apart in the width direction of the guide surface 316 (the direction perpendicular to the conveyance direction of the paper P). By this means, deformation of the paper P is suppressed and the paper P can be guided smoothly.

In this case, there are no particular restrictions on the shapes of the suction holes 318. In the example shown in FIG. 14A, the shape of the suction holes 318 is an oval shape extending in a direction parallel to the conveyance direction of the paper P. Consequently, it is possible to raise the holding force while suppressing deformation of the paper P. Besides a shape in which either end is formed in a circular arc shape, as shown in FIG. 14A, the oval hole shape may also include an elliptical shape or a rectangular shape, or the like (in other words, a hole shape having different vertical width and lateral width).

FIG. 14B shows a case where a plurality of suction holes 318 are formed at a uniform pitch along the width direction of the guide surface 316, and furthermore, the shape of each suction hole 318 is an oval hole and the holes are formed in inclined fashion with respect to the conveyance direction of the paper P, in such a manner that the upstream side end portion of each suction hole 318 in terms of the conveyance direction of the paper P is positioned towards the center of the guide surface 316 with respect to downstream side end portion. In this case, as shown in FIG. 14B, the suction holes 318 are formed in left/right symmetry with respect to the center of the width direction of the guide surface 316, and are formed so as to diverge in the conveyance direction of the paper P.

By forming the suction holes 318 in this way, it is possible to extend creases from the center of the paper P towards the ends in the width direction, when the paper P slides over the guide surface 316. Consequently, it is possible to prevent the occurrence of creasing more effectively.

Similarly to FIG. 14B, FIG. 14C shows a case where a plurality of suction holes 318 are formed at a uniform pitch along the width direction of the guide surface 316, and furthermore, the shape of each suction hole 318 is an oval hole and the holes are formed in inclined fashion with respect to the conveyance direction of the paper P, in such a manner that the upstream side end portion of each suction hole 318 in terms of the conveyance direction of the paper P is positioned towards the center of the guide surface 316 with respect to the downstream side end portion. However, in the present embodiment, the angle of inclination becomes larger, the further the position of the suction hole 318 from the center of the guide surface 316.

By forming the suction holes 318 in this way, it is possible to gradually stretch creases from the center of the paper P towards either end in the width direction, and the beneficial effects of stretching the creases are further enhanced.

FIG. 14D shows a case where the slit-shaped suction holes 318 are arranged in left/right symmetry with respect to the center of the guide surface 316 in the width direction, and are formed at an inclination with respect to the conveyance direction of the paper P in such a manner that the upstream side end portion of each suction hole 318 in terms of the conveyance direction of the paper P is positioned on the center side of the guide surface 316 with respect to the downstream side end portion. In this case, as shown in FIG. 14D, the suction holes 318 are formed in a divergent fashion in the conveyance direction of the paper P.

If the suction holes 318 are formed in this way, it is possible to gradually extend creases from the center of the paper P towards either end in the width direction, and it is possible to prevent the occurrence of creases effectively.

FIG. 14E shows a case where a plurality of suction holes 318 are formed at a uniform pitch in the width direction of the guide surface 316, and furthermore the shape of the suction holes 318 is an oval shape and the suction holes 318 are formed in an inclined fashion with respect to the conveyance direction of the paper P.

By forming the suction holes 318 in this way, it is possible to extend creases from one side of the paper P towards the other side in the width direction, when the paper P slides over the guide surface 316.

FIG. 14F shows a case where a slit-shaped suction hole 318 is formed along a diagonal of the guide surface 316 (where a slit-shaped suction hole 318 is formed at an inclination with respect to the conveyance direction of the paper P).

By forming the suction hole 318 in this way, it is possible to extend creases from one side of the paper P towards the other side in the width direction, when the paper P slides over the guide surface 316. Furthermore, it is also possible to suction the paper P continuously in the width direction, and a high holding force can be obtained.

Similarly to FIG. 14F, FIG. 14G shows a case where a slit-shaped suction hole 318 is formed along a diagonal of the guide surface 316, in addition to which a plurality of suction holes 318 are formed in parallel with this suction hole 318.

By forming the suction holes 318 in this way, it is possible to extend creases from one side of the paper P towards the other side in the width direction, when the paper P slides over the guide surface 316, as well as being able to further increase the holding force.

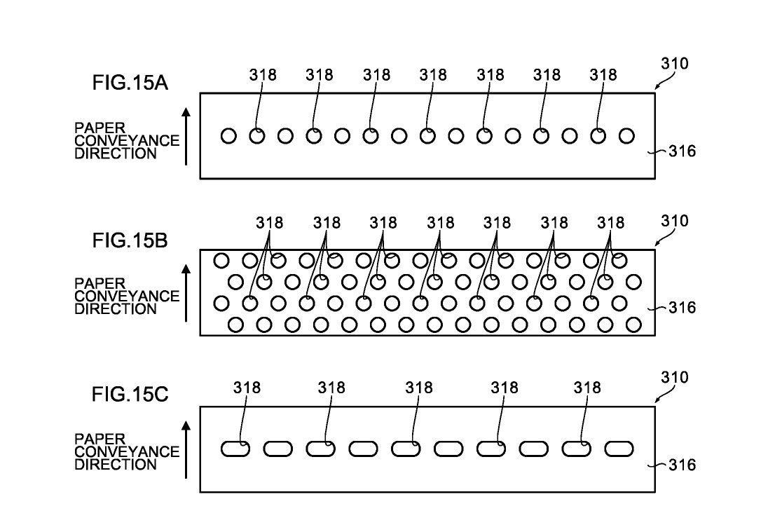

FIGS. 15A to 15C are diagrams showing yet a further mode of the suction hole formed in the guide surface.

In the modes shown in FIGS. 14A to 14G, the shape of the suction holes 318 is an oval shape or a slit shape, but the shape of the suction holes is not limited to this.

FIG. 15A shows a case where a plurality of circular suction holes 318 are formed at uniform intervals apart in the width direction of the guide surface 316 (the direction perpendicular to the conveyance direction of the paper P). By forming the suction holes 318 in a circular shape, it is possible to make processing easier.

FIG. 15B shows a case where a plurality of circular suction holes 318 are formed in the guide surface 316. By this means, it is possible to increase the suctioning surface area and to further raise the holding force.

FIG. 15C shows a case where a plurality of suction holes 318 are formed at uniform intervals apart in the width direction of the guide surface 316, and the suction holes 318 have an oval shape extending in the width direction of the guide surface 316. Accordingly, it is possible to suppress deformation of the paper P, while raising the holding force.

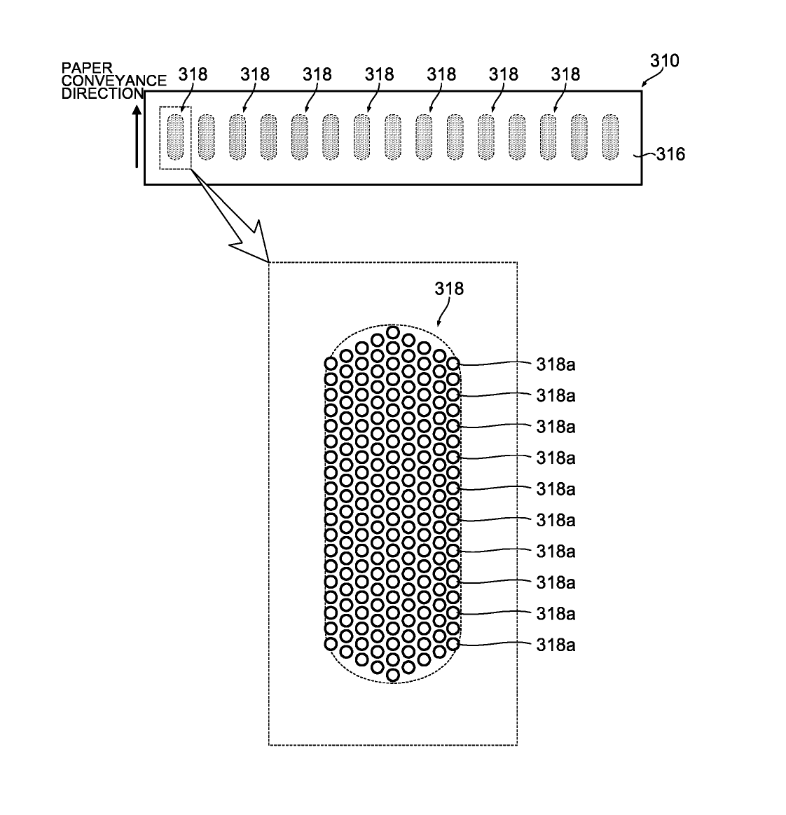

If the suction holes 318 have an oval shape, then as shown in FIG. 16, it is also possible to form an overall oval shape by concentrating a large number of circular holes 318a of small diameter (in such a manner that the overall outer shape is oval). Accordingly, it is possible to suppress deformation of the paper P, while obtaining a high holding force. Furthermore, processing can be carried out easily.

In the example described above, for the sake of the description, the guide surface 316 is formed in a flat shape, but the shape of the guide surface 316 is not limited to this. When suction holes 318 are formed in a guide surface 316 according to another mode, it is possible to form suction holes 318 of the various modes described above.

### ((Further Modes of Paper Guide Installation Method))

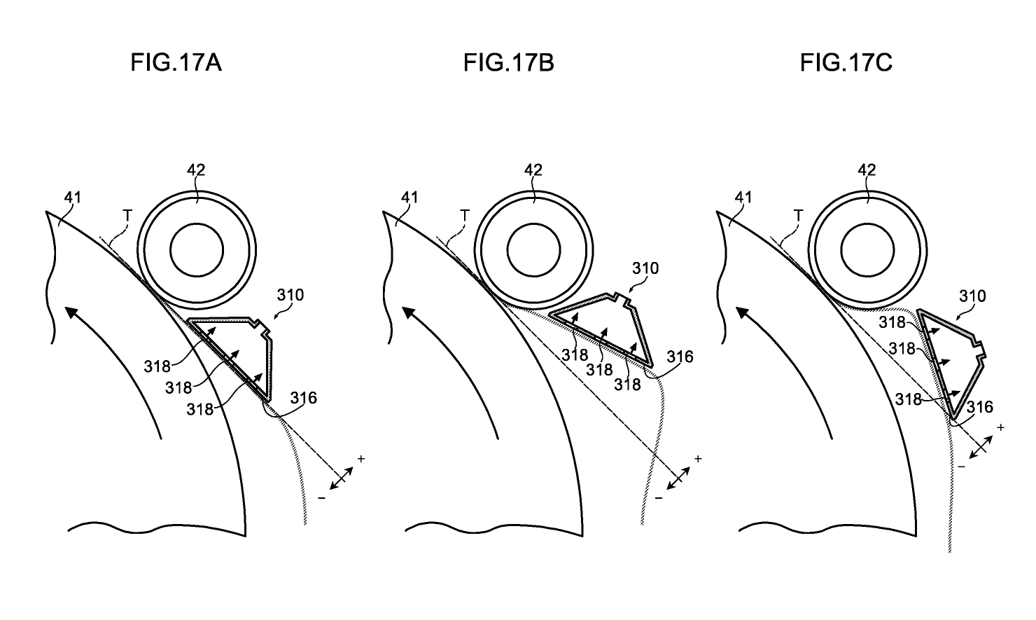

As shown in FIG. 17A, in the embodiment described above, the paper guide 310 is arranged in such a manner that the guide surface 316 follows a tangent T to the image recording drum 41 at the installation point of the pressing roller 42 (the paper guide 310 is arranged in such a manner that the installation point of the pressing roller 42 is situated on an extension line of the guide surface 316). By arranging the paper guide 310 in this way, the paper P can be introduced readily between the pressing roller 42 and the image recording drum 41, and the effects of preventing creases can be further enhanced.

On the other hand, by arranging the paper guide 310 in such a manner that the paper P passing the paper guide 310 is wrapped about the pressing roller 42, as shown in FIGS. 17B and 17C, then the surface area over which the paper P travels along the pressing roller 42 is increased, and the beneficial effects of extending the creases by the pressing roller 42 are raised.

In this case, as shown in FIGS. 17B and 17C, it is possible to install the guide surface 316 at an inclination with respect to the tangent T of the image recording drum 41 at the installation point of the pressing roller 42 (the direction in which the paper P is suctioned by the guide surface 316 is inclined with respect to the tangent T). Therefore, it is possible to suction the paper P in such a manner that the paper P passing over the paper guide 310 wraps about the pressing roller 42.

In particular, as shown in FIG. 17C, by providing the guide surface 316 at an inclination in a negative direction with respect to the tangent T (in other words, in such a manner that the direction in which the paper P is suctioned at the guide surface 316 is in the opposite direction from the installation point of the pressing roller 42), then the force of the back tension can be raised.

In this way, by adjusting the installation position of the paper guide 310, it is possible to adjust the mode of applying back tension and the mode of introducing the paper P in between the pressing roller 42 and the image recording drum 41, and so on. Consequently, it is desirable to install the paper guide 310 in the most appropriate state, in accordance with the type and thickness of the paper P used, and the like. Furthermore, is also possible to make the installation position adjustable in such a manner that the mode of suctioning is changed, in accordance with the type and thickness of the paper P, and the like. For example, the paper guide 310 is supported so as to pivot about an axis parallel to the axle of the image recording drum 41, in such a manner that the orientation (suctioning direction) of the guide surface 316 can be altered. By this means, it is possible to adjust the mode of suctioning. Furthermore, it is also possible to make the height position of the paper guide 310 from the outer circumferential surface of the image recording drum 41 adjustable (in other words, to make the gap formed between the outer circumferential surface of the image recording drum 41 and the guide surface 316 adjustable).

Moreover, desirably, the paper guide 310 is arranged with the guide surface 316 as close as possible to the outer circumferential surface of the image recording drum 41. Consequently, it is possible to suction the paper P in a stable fashion.

### ((Further Modes of Paper Guide))

A stronger holding force can be obtained, the greater the contact surface area between the paper guide 310 and the paper P. Consequently, the greater the length of the guide surface 316 in the paper conveyance direction (the length in the front/rear direction), the better. This length is set by taking consideration of the installation space, and the like, and is set to a length whereby the greatest beneficial effects are obtained.

Furthermore, desirably, the length in the direction perpendicular to the conveyance direction of the paper P is set to be substantially the same as the paper width. Consequently, it is desirable to form the guide surface 316 to substantially the same width as the width of the image recording drum 41.

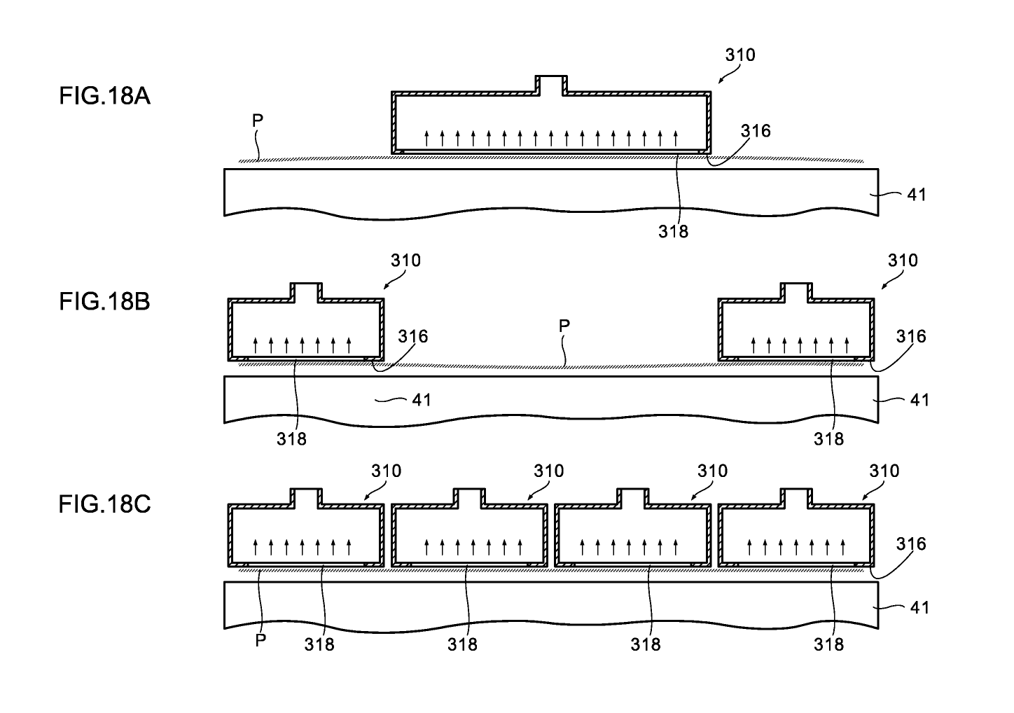

However, it is also possible to adopt a composition whereby, depending on the installation space and the type of paper P used, and the like, only the central portion of the paper P is suctioned, as shown in FIG. 18A.

Furthermore, as described in FIG. 18B, it is also possible to adopt a composition in which the respective end portions in the width direction of the paper P are suctioned by using a pair of paper guides 310.

Moreover, it is also possible to adopt a composition in which a plurality of paper guides 310 are aligned in a direction perpendicular to the conveyance direction of the paper P. In this case, it is also possible to adopt a composition which suctions the respective paper guides 310 by using one vacuum pump, and it is also possible to provide vacuum pumps individually for each paper guide 310, so as to be able to perform suctioning individually. By this means, it is possible to switch the width that is suctioned, in accordance with the size of the paper P. Even in a case where one vacuum pump is used, it is possible to obtain similar beneficial effects by providing valves in the suction pipes which connect the paper guides 310 with the vacuum pump (so as to be able to switch suctioning on and off, independently).

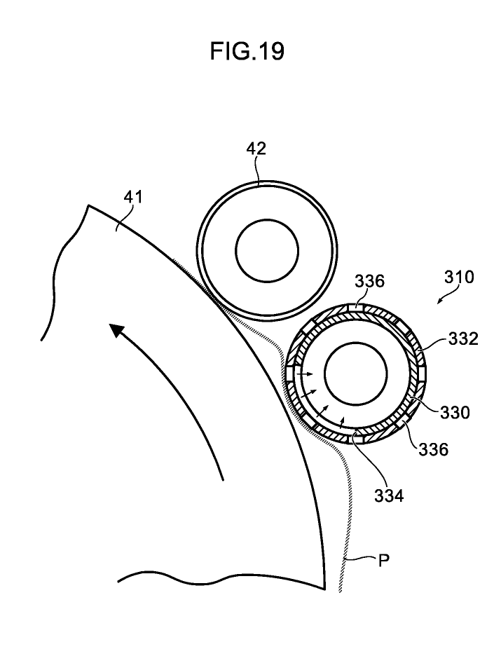

Furthermore, as shown in FIG. 19, the paper guide 310 can also be formed in a roller shape.

The paper guide 310 shown in FIG. 19 is constituted by a dual-tube structure including an inner tube 330 and an outer tube 332, and is formed to substantially the same width as the image recording drum 41.

The inner tube 330 is formed in a round cylindrical shape. Either end of the inner tube 330 is supported on a bracket, which is not illustrated, and is provided in a fixed manner.

The outer tube 332 is formed in a round cylindrical shape. The outer tube 332 is provided so as to rotate about the outer peripheral portion of the inner tube 330, via a bearing, which is not illustrated.

An opening section 334 is formed in a prescribed angular range in the circumferential surface of the inner tube 330. On the other hand, a plurality of suction holes 318 are formed in the outer circumferential portion of the outer tube 332.

A suction hole (not illustrated) is formed in one end of the inner tube 330. The suction hole is connected to a vacuum pump via a suction pipe.

When the vacuum pump is driven, the air inside the inner tube 330 is suctioned. Consequently, air is suctioned from the suction holes 318 formed in the outer tube 332. By suctioning the air from the suction holes 318, the front surface of the paper P conveyed by the image recording drum 41 is suctioned.

By suctioning the paper P via the suction holes 318, the paper P is caused to making tight contact with the outer circumferential surface of the outer tube 332. The outer tube 332 is provided rotatably, and therefore rotates in conjunction with the travel of the paper P (joint rotation).

By forming the paper guide 310 in a roller shape in this way in such a manner that the paper guide rotates jointly with the paper P, it is possible to prevent rubbing of the front surface of the paper P.

In the present example, the outer tube 332 is supported rotatably on the outer circumference of the inner tube 330 and rotates jointly with the paper P, but it is also possible to adopt a composition in which the outer tube 332 is driven by a rotation driving device, such as a motor, so as to rotate at the same speed as the paper P.

Furthermore, it is also possible to adopt a composition in which the outer tube 332 is driven by a rotation driving device, such as a motor, so as to rotate in the opposite direction to the conveyance direction of the paper P. Consequently, it is possible to increase the force of the back tension.

### ((Suction Method))

It is possible to adopt a composition in which the back tension application device 300 operates continuously while the inkjet recording apparatus 10 is operating, so as to suction air with a uniform suction force at all times from the paper guide 310, but desirably the suction force is controlled in accordance with the conveyance of the paper P.

For example, the paper P is suctioned with a strong suction force in the leading end portion of the paper P, whereupon the suction force is weakened. Once the paper P has been suctioned, the paper P can be held in this state, but if the initial suction force is weak, then there is a risk that suctioning will not be possible. Therefore, the paper P is suctioned with a strong suction force in the leading end portion of the paper P, whereupon the suction force is weakened. Consequently, it is possible to suction the paper P in a suitable fashion.

Apart from this, it is also possible to weaken the suction force gradually towards the trailing end of the paper P.

### ((Other Embodiments))

In the embodiment described above, an example is described in which the present invention is applied to a paper conveyance mechanism of an image recording drum 41, but it is also possible to apply the present invention to another paper conveyance mechanism. For instance, the present invention can also be applied to a paper conveyance mechanism of the treatment liquid application unit 30. In this case, a back tension deposition apparatus is provided at a position immediately before the application apparatus 32 (application roller). Consequently, it is possible to prevent the occurrence of creases in the paper P which is pressed by the application roller.

Furthermore, it is also possible to adopt a composition in which a plurality of paper guides 310 are arranged along the conveyance direction of the paper P.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A paper conveyance apparatus which conveys cut sheet paper; comprising:
a drum which conveys the paper by wrapping the paper around an outer circumferential surface of the drum and rotating;
a pressing roller, at least an outer peripheral portion of which is formed by an elastic body, the pressing roller pressing a front surface of the paper at a prescribed position on the outer circumferential surface of the drum to cause a rear surface of the paper to make tight contact with the outer circumferential surface of the drum; and
a back tension application device which applies a back tension to the paper which is introduced between the drum and the pressing roller.

2. The paper conveyance apparatus as defined in claim 1, wherein an outer diameter of the pressing roller is formed so as to become smaller from a center towards respective ends.

3. The paper conveyance apparatus as defined in claim 1, wherein an outer diameter differential and a pressing force of the pressing roller are set so as to make tight contact with a whole region of the paper in a width direction thereof.

4. The paper conveyance apparatus as defined in claim 2, wherein an outer diameter differential and a pressing force of the pressing roller are set so as to make tight contact with a whole region of the paper in a width direction thereof.

5. The paper conveyance apparatus as defined in claim 1, wherein a plurality of the pressing rollers having mutually different outer diameter differentials are prepared, and the plurality of the pressing rollers are exchangeable.

6. The paper conveyance apparatus as defined in claim 4, wherein a plurality of the pressing rollers having mutually different outer diameter differentials are prepared, and the plurality of the pressing rollers are exchangeable.

7. The paper conveyance apparatus as defined in claim 1, wherein spiral-shaped grooves are formed from a center towards respective ends in a circumferential surface of the pressing roller.

8. The paper conveyance apparatus as defined in claim 7, wherein a groove depth and a pressing force of the pressing roller are set so as to make tight contact with a whole region of the paper in a width direction thereof.

9. The paper conveyance apparatus as defined in claim 7, wherein a plurality of the pressing rollers having mutually different groove inclination angles are prepared, and the plurality of the pressing rollers are exchangeable.

10. The paper conveyance apparatus as defined in claim 8, wherein a plurality of the pressing rollers having mutually different groove inclination angles are prepared, and the plurality of the pressing rollers are exchangeable.

11. The paper conveyance apparatus as defined in claim 1, wherein the back tension application device applies a back tension to the paper by suctioning the front surface of the paper at a position immediately before the paper is introduced between the drum and the pressing roller.

12. The paper conveyance apparatus as defined in claim 11, wherein
the back tension application device comprises:
a paper guide which has a guide surface on which the front surface of the paper slides, with a suction hole being formed in this guide surface; and
a suctioning device which causes the front surface of the paper to make tight contact with the guide surface by suctioning from the suction hole.

13. The paper conveyance apparatus as defined in claim 1, wherein the drum has a suction holding device which suctions and holds a rear surface of the paper wrapped around the outer circumferential surface of the drum.

14. The paper conveyance apparatus as defined in claim 1, wherein the drum has a leading end gripping device which grips a leading end of the paper.

15. An inkjet recording apparatus, comprising:
the paper conveyance apparatus as defined in claim 1; and
an inkjet head which ejects an ink droplet onto the front surface of the paper conveyed by the drum.
